(19) United States
(12) Patent Application Publication
(10) Pub. No.: US 2020/0238952 A1
(43) Pub. Date: Jul. 30, 2020

(54) FACIAL RECOGNITION SYSTEMS FOR ENHANCED SECURITY IN VEHICLES AND OTHER DEVICES

(71) Applicants: Jeffrey Dean Lindsay, Appleton, WI (US); Meliah Elizabeth Lindsay, Appleton, WI (US)

(72) Inventors: Jeffrey Dean Lindsay, Appleton, WI (US); Meliah Elizabeth Lindsay, Appleton, WI (US)

(21) Appl. No.: 16/773,985

(22) Filed: Jan. 28, 2020

Related U.S. Application Data
(60) Provisional application No. 62/797,406, filed on Jan. 28, 2019.

(51) Int. Cl. B60R 25/25; G06K 9/00; G08B 25/12; B60R 25/30; B60R 25/20; B60R 25/24; B60R 21/01; B60R 25/102; B60W 60/00; B60R 25/40

(52) U.S. Cl. CPC B60R 25/25; G06K 9/00288; G06K 9/00892; G06K 9/00255; G08B 25/12; B60R 25/305; B60R 2025/1016; B60R 25/2054; B60R 25/24; B60R 21/01; B60R 25/102; B60W 60/0015; B60R 25/40; B60R 25/2045

(57) ABSTRACT

Security systems for secured assets such as vehicles, are described in which facial recognition systems or other biometrics systems provide enhanced security for an authorized user. Subtle or covert cues provided by the user during authentication or subsequent monitoring of the user by the facial recognition system and other input systems are used to invoke user-editable personal security rules that respond to the cues to implement the user's desired responses for added security in various situations. Related security systems, methods, and devices are described to protect an asset such as an automobile or other vehicle or other secured asset through the use of biometrics and personal security rules. In such systems, a training module may provide periodic training and practice sessions to assist the user in being prepared to properly use the personal rules system in response to various scenarios and threats, and can guide adjustment of personal rules for better success.

### CROSS-REFERENCE TO RELATED APPLICATIONS

This application claims priority to U.S. Provisional Application 62/797,406, filed Jan. 28, 2019 by Jeffrey Dean Lindsay and Meliah Elizabeth Lindsay, the entirety of which is incorporated herein by reference.

### BACKGROUND

### Field of the Invention

This invention pertains to automobile security and to enhanced security in other devices and assets whether mobile or stationary, whether primarily mechanical or electronic, wherein facial recognition systems are incorporated with subtle customized rules to give users added control and added security against theft, hackers, or other threats. The invention also pertains to the use of facial recognition systems with subtle rules to customize access to computerized systems and accounts, including access interfaces for automobiles, planes, drones, boats, safes, and other devices or assets.

### Background

Automobiles and many other vehicles and assets have historically been protected with simple keys and locks. Some now permit access by entry of a numeric PIN or other password. Electronic devices and electronic accounts have largely relied on passwords or PINS based on simple text strings to authenticate users. More recently biometrics have come into play, as illustrated by U.S. Pat. No. 6,498,970, “Automatic access to an automobile via biometrics,” issued Dec. 24, 2002 to A. Colmenarez et al.; U.S. Pat. No. 10,173,643, “Object detection for vehicles,” issued Jan. 8, 2019 to S. V. Myers et al.; U.S. Pat. No. 7,088,220, “Method and apparatus using biometric sensors for controlling access to a wireless communication device,” M. D. Kotzin, issued Aug. 8, 2006; U.S. Pat. No. 7,406,368, “Apparatus, system and method for aircraft security and anti-hijacking intervention,” issue Jul. 29, 2008 to M. Arnouse; U.S. Pat. No. 6,989,737, “Vehicle antitheft device,” issued Jan. 24, 2006 to K. Yasui; U.S. Pat. No. 9,576,189, “Method and apparatus for controlling vehicle using motion recognition with face recognition,” issued Feb. 21, 2017 to Y. Lim et al.; and U.S. Pat. No. 7,110,570, “Application of human facial features recognition to automobile security and convenience,” issued Sep. 19, 2006 to J. J. Berenz et al. Voice recognition and now facial recognition have also become increasingly popular. However, all of these systems are subject to theft from sometimes simple means. Keys are relatively easy to steal or duplicate and sometimes can be picked or defeated in other ways when a key is unavailable, resulting in complete loss of the vehicle or asset. Passwords can be observed by onlookers, hidden cameras, and key loggers, or obtained by phishing, hacking of servers, or other hacking techniques.

Biometrics may help but are far from foolproof. Fingerprints can be easily obtained and replicated to defeat fingerprint sensors. Voices can be recorded and replayed. Faces can be photographed and printed to fool a facial recognition system, or faces can be spoofed with nearly identical masks. As the techniques of thieves and hackers become increasingly sophisticated, there is a growing need to strengthen security measures without making them major barriers to use. For example, enforcing complex, hard-to-hack passwords with complex rules frequently results in users being forced to have passwords that are too difficult to remember, and thus they may be written down on scraps of paper next to computers to make theft easier than ever. Password management systems also can be vulnerable, and once hacked, a thief may obtain access to many accounts managed by the system. For high value accounts especially, there is a need for additional protection.

Further, even security-conscious users may sometimes face situations in which they feel they must use their passwords in insecure settings where the password may be exposed to others. Even worse, some may face criminal intimidation in which the threat of harm or other threats are used to force a person to provide access to a vehicle or account or other asset, such as by handing over keys, revealing a password or other security code. In other situations, an account owner may face a need to voluntarily share a password or other credential with another trusted party, with the risk that it may be obtained by others or be misused by the trusted party. In these cases, there is a need for added security to protected assets in order to prevent problems such as vehicle theft, account hijacking and identify theft, or to reduce the risks of misusing an account or information from an account.

This is particularly true with regard to systems incorporating facial recognition for security, as the ability of thieves to product realistic simulations of a user's face has become increasingly sophisticated. Systems have been proposed to require motion, glint from the eyes changing due to changes in light, or gestures to confirm that an image is from a live person, but even such anti-spoofing measures don't resolve many security threats and can still be defeated with suitable sophistication. Even without sophisticated tools, crude techniques can still be devastatingly successful: a thief can use the threat of bodily harm to force an account owner of, say, an iPhone with facial recognition systems for authentication to use his or her face to authorize a fraudulent payment or to unlock the phone and disable security features, giving the thief full access to the phone and the accounts it may open or access.

There is a growing need for enhanced security systems incorporating facial recognition and other biometric measures which can defeat simple or sophisticated efforts to gain access through a biometric authentication procedure. Further, in contrast to the trend of forcing all users to follow complex rules regarding passwords that can result in barriers to use and security, there is an increasing need to provide customized control over secured assets to meet the personal needs and abilities of users, while still providing high levels of security that cannot be easily defeated by something as simple as observing password entry or stealing a key. (Customized security rules with primary and secondary passwords and the use of covert means to control access are disclosed in U.S. Pat. No. 7,552,467, issued Jun. 23, 2009, and U.S. Pat. No. 9,959,694, issued May 1, 2018, both entitled “Security System for Protecting an Asset” issued to J. D. Lindsay, both hereby incorporated by reference in their entireties.)

Further, in coping with duress or even intentionally allowing family or friends to use an account, there is a growing need for customized control over the access provided, including the option for both real but limited and also deceptive (feigned) access to an account or asset in order to control what can and cannot be done in order reduce loss or other risks. Regarding deceptive access, in some situations, there is also a need to provide a user improved security means to placate a thief or appear to provide access to an asset, without actually jeopardizing the asset or selected components of the asset.

One or more of these needs may be addressed in the various aspects of the invention described below, but it should be recognized that particular aspects of the invention as defined by the claims may provide utility in a variety of other areas and need not specifically address any of the needs previously set forth or any objectives or advantages explicitly or implicitly found elsewhere in the specification.

### SUMMARY

Inventive scenario #1: When the owner of a future car approaches her vehicle, its facial recognition system (including cameras on the car operatively associated with suitable processors, software, and memory comprising image data for authorized users) will already have recognized her gait as well as her face as she nears the vehicle.

Noting that another unfamiliar person is accompanying the owner, the window of whatever door she approaches will light up as a display screen showing the familiar avatar for her autonomous driver. “Hello, Sandra. Is everything OK?” the autonomous driver will ask through the external speaker system. As Sandra nears the window, she may briefly wrinkle her nose, then smile broadly with her teeth apart, and say, “Yes, Charles, everything is AOK. Let us in, please.” The vehicle recognizes the rarely used “AOK” command as a duress warning and immediately begins covertly communicating with local police. The vehicle also recognizes the sequence of a wrinkled nose followed by a broad smile with opened teeth as a command for rescue from an armed threat, following Sandra's prior selections and honed in automatically provided practice drills and related training from the training module incorporated with the system, the car's training module has helped Sandra practice many times. But this is not a drill.

The vehicle wirelessly relays information to the police about a possible kidnapping situation, transmitting images of the companion and video of the events, highlighting what appears to be a gun under a sweater, and, according to requirements of local law, requests authorization for a forcible rescue operation in light of the evidence submitted and the licensing/certification previously obtained,. Meanwhile, the door nearest Sandra and her companion will pop open as normal, allowing the two to enter into the back seat. The companion speaks and gives an address as their destination. “Sandra, can you confirm?” asks the vehicle. “Yes, Charles. Please hurry.” “Very well, but both of you must first buckle your seatbelts before we begin.” After the seatbelts are buckled, the vehicle begins driving as the police authorization is received.

At a suitable moment when it appears that the companion's hidden weapon is no longer actively pointed at the owner, the vehicle suddenly swerves, honks and violently slams to a halt. Simultaneously, the security system by design causes an airbag to be deployed in front of the criminal, stunning him. Sandra's seatbelt is instantly released, her door is automatically opened, and she flees from the vehicle as her door closes and locks. The stunned man struggles but cannot release his seatbelt nor open his door. Two policeman show up moments later to arrest the would-be kidnapper. Sandra's Private Rules for vehicle security incorporating facial and voice recognition may have saved her life.

An apparently missing aspect in previous considerations of facial recognition for account access is the opportunity to add hidden layers of security and customized control to a secured asset such as an automobile or smartphone through the use of an improved facial recognition system that can recognize not just a face but a sequence of facial expressions and physical motions, and/or one or more unusual facial expressions, to not only govern access, but to govern various levels of access as well as the possibility to request and execute various security-related commands, as desired. Such sequences or expressions can be associated with customized rules selected by the user to provide additional directions to the security system that incorporates facial recognition for protection of the asset. The additional directions that can be conveyed through a sequence of facial expressions and/or unusual expressions can be used to not merely provide or deny access, but to enable a variety of other functions to meet the security needs of an individual user, including, for example, the ability to offer limited access to the asset such as limitation in performance or function in a vehicle or other device, limitation in the financial amount or other measure of value that can be affected (spent, transferred, etc.), limitation in the geographical region that an asset can be used, limitation in what the asset can be used for (e.g., payments that can only be made for utilities, groceries, or gas, or driving a vehicle only to school or educational events), or limitation in time such as only providing temporary access to the asset or only providing access at certain times of day, days of the week, etc. In some cases, the limitations can be so severe that access is substantially in appearance only, i.e., deceptive access (or merely feigned), which can nevertheless convince a thief that access has been obtained, and thus may be able, for example, to placate a thief who was using the threat of force to compel a user to provide access.

Thus, in one embodiment, a transportation device is equipped with a security system in communication with a facial recognition system comprising one or more cameras, a memory, and a processor, the security system optionally also comprising one or more additional input devices such as a microphone for receiving sound, a motion detector for receiving data based on motion, a load cell for receiving data based on the force applied to an object accelerometer or vibration sensor, an infrared signal detector, etc., the facial recognition memory (which may be physically remote from the one or more cameras or may be integrated with or physically connected to a housing holding the camera) comprising:
(a) a database of authorized users each associated with respective facial recognition data,
(b) software for identifying one or more authorized users on the basis of comparing one or more images or hashes thereof (including a series of images in time or video content) obtained by the one or more cameras with the facial recognition data in the database, and
(c) user-edited personal rules that specify, for one or more of the authorized users, one or more security actions to be taken by the security system in response to a specific action of the one or more of the authorized users, said security actions being selected from limited access, deceptive access, alarmed access, or denied access, and said specific action being selected from a predetermined signal from the user detectable via the camera and/or the one or more optional input devices if present, such as a verbal signal received by an audio input system, a covert action or signal visible to the one or more cameras, or a combination thereof, including an action made with a visible body motion selected from a gesture, a series of gestures, a facial expression, a series of facial expressions, or any combination thereof,

wherein the security system is adapted to, in response to a predetermined signal as defined by the personal rules, provide a form of access to the automotive device selected from limited access, deceptive access, alarmed access, and denied access. The resulting access provided to the user and/or others accompanying the user may be at least one: preventing entrance to the transportation device; preventing use of the transportation device after entrance; providing a limited ability to use the transportation device, with limitations on factors such as maximum speed, distance the device can travel, other performance or mechanical limitations, etc.; providing an escape opportunity for the user and/or restraint of an assailant; issuing a call for help or other alarms, etc.

As used herein, “limited access” gives the user the ability to use or access the protected asset in some way, but with limitations that may reduce risk or costs. Limited access in the context of vehicles may impose limitations as to how far the vehicle may travel, how long it may be used, how fast it may go, where it may go (e.g., access to a secure parking facility, access through the gate of a secure facility, crossing a political or legal boundary, etc.), where it may be parked, what services it may provide or receive (e.g., Wi-Fi, satellite radio, streaming video, valet parking, etc.), etc. For financial accounts, limited access can prevent a user from seeing how much is in the account, from spending more than a specific amount of money, limiting where charges may be made or for what kinds of services and products (e.g., only for gasoline within 50 miles of home, or only for books, school fees, and groceries), or restricting the types of transactions that may be made (e.g., no interbank transfers). For access to a building or other facility, limited access can restrict which elevators or which floors or which rooms a user may enter, or restrict when they can be entered, or require that another authorized user be present as a chaperone. Limited access may also restrict the use of electronic devices, communication systems, websites, goods that can be purchased or removed from a facility, and so forth.

As used herein, “deceptive access,” sometimes synonymous with “feigned access,” refers to allowing a user to assume that the credentials provided have been accepted and that a desired level of access has been granted, when in fact it has not been. Some level of deception is involved, such as showing the user options for functions that are not available, modifying a user interface to make it seem that a transaction has occurred or will be processed when it has been rejected, displaying information that is not completely accurate such as showing an account balance much less than the real balance, indicating success for an operation that will not occur, simulating significant slowing of actions taken in a user interface to discourage a user and limit what can be done in a given amount of time, etc. In a vehicular setting, deceptive access can suggest, via a dashboard, control panel, or apparent initial performance of the vehicle, that the user has full access, when in fact there are significant limitations. Deceptive access can include displaying a very low gas tank level or battery charge reading when the actual level is much higher, feigning an out-of-fuel/charge incident when there is still adequate fuel/charge, reducing the maximum speed obtainable by the car, feigning a mechanical breakdown through both performance problems and dashboard alerts, causing a tire to go flat when it has not been pierced or damaged, causing a significant slow down in speed, and locking a door that appears to be unlocked, blocking telecommunications, etc. Note that embodiments involving devices, particularly mobile devices such as transportation devices or portable electronic devices, the device typically employs a source of stored energy, wherein the source of stored energy may be a battery, a fuel reservoir such as a gasoline tank, a fuel cell, a tank of a liquefied or compressed natural gas or compressed air or other compressed gases, chemical reactants such as a solid fuel source or propellant, and the like. The device may also provide a signal or display conveying the level of the stored energy, which may be deliberately modified in embodiments pertaining to deceptive access to the mobile device. Thus, in one embodiment, after a user employs facial recognition to gain access to a mobile device such as a cell phone or automobile, if a covert cue required for full access according to the user's personal rules was missing, the security system for the device may provide deceptive access comprising showing a low battery or low fuel signal resulting in deceptive shut down or failure of the device after a few seconds of use. In such cases, another covert cue may be required, possibly after attempted charging or addition of fuel, before the device can be reactivated for login or a device start attempt. Such a covert cue could include shaking a cell phone in a particular way as the power button is pushed, or kicking a tire, slamming a door, twisting the steering wheel, adjusting a seat position or the rear-view mirror before starting the vehicle.

As used herein, “alarmed access” indicates that security alarm is triggered, which may be an overt or silent alarm. The security alarm may comprise contacting police or other authorities to indicate that a crime, high-risk situation, or other emergency is in progress that requires attention such as a rescue operation, a police escort, stopping the vehicle, and so forth. In one embodiment, an alarmed access situation may yield some element of control of the transportation device to authorities to assist in emergency measures, such as taking over control or causing the transportation device to stop when desired or unlocking one or more doors to permit rescue or escape.

As used herein, “denied access” can refer to clearly rejecting a user's attempt to access an asset, such as a door or barrier not opening in response to providing passwords, providing an alert indicating that access has been denied, etc. However, the denial can be done without obvious notification but by simply not providing access or by causing the user interface to freeze.

As used herein, a “barrier” to access of a transportation device or other device can include the door and the lock on a vehicle's door, as well as other components of the vehicle that a user may remove or open to enter the device, such as the roof of a convertible automobile. The barrier may also be the ignition system that requires a physical or electronic key or wireless signal in order to start a vehicle. In some embodiment, the access to the vehicle may be protected by a physical structure such as a garage or door, removable barricade, or other object that prevents the vehicle from being driven. For a motorcycle, bicycle, boat, etc., a physical lock as in a lock and chain or other lock systems may protect the device.

Various elements of the security system may be associated with other devices or facilities other than a transportation device, such as an electronic account accessed via a GUI on a computer or mobile device; point-of-sale devices, check-out stations, or purchasing kiosks at a store, mall, restaurant, or commercial or private facility; a safe or vault; a secured structure or building or room; a weapon; a storage unit; a refrigerator; a cabinet; a health care facility; a cell phone; and the like.

For the devices and systems described herein, the use of one or more cameras may include a smartphone camera in communication with the security system via an app or website. For embodiments with a transportation device, the one or more cameras may include a at least one camera mounted on the transportation device, which may include being mounted on a fixed, immobile structure in proximity to the transportation device. The transportation device may be adapted for transportation over land, for flight, or in or on water, and may be an automobile, a truck, a forklift or other industrial transport vehicle, a boat or other watercraft including a submarine, an aircraft such as an airplane or helicopter, a space vehicle, an elevator or other means for transport between the floors of a building, a moving walkway, a hovercraft, etc.

Devices or systems described herein may comprise a user interface comprising at least one of a visual display and an audio input/output system, and wherein the wherein the user interface is activated prior to entry of an authorized user into a vehicle or more generally prior to access of protected asset. The user interface may be adapted to receive visual and verbal signals from the authorized user to select and apply one or more personal rules.

The use of facial recognition systems to protect an asset can involve a facial recognition system that is physically associated at least in part with the asset, such as cameras being physically installed on or near a portal, door, or other device or barrier controlling access to the asset, and may include one or more cameras on a vehicle that move with the vehicle, or may be fixedly mounted on a structure near the vehicle such as on a portion of the structure of a parking garage. The one or more cameras may also be mounted on the walls, doors, or fencing of a home, office, factory, or other building, such as one or more cameras associated with an elevator system (e.g., fixedly mounted near the elevators such that the cameras do not move with the elevator, or mounted inside the elevator, or both), building entry system, home security system, electronic doorbell system, gated community entrance, etc.

In other embodiments, the facial recognition system may comprise the camera of a cell phone or other mobile electronic device. Thus, in one embodiment, an authorized user of a secured asset wishing to or needing to access the asset in some way (here the asset may be the cell phone itself, as in unlocking it to access features, and/or an asset such as a bank account or a vehicle accessible via the cell phone) first authenticates herself using a facial recognition system that involves the use of the smart phone or other portable device to obtain one or more images of the user and optionally a verbal message or other forms of input via user actions. The action may include submitting a password (including a PIN) entered by alphahumeric or character input including typing, drawing a character, using swiping motions, voice recognition, etc.; or physical actions with the phone or other input device such as holding it at a specific angle, shaking it or rotating it in a predefined manner, tapping specific portions of an image, pressing a portion of a screen or button or other pressure sensitive component in a predefined way, etc. Upon identifying the user as an authorized user on the basis of facial recognition and/or other inputs, the security system protecting the asset can determine if the user has established personal rules involving the facial recognition system to govern access to the asset and, if so, the system will evaluate the one or more images already obtained and submitted by the user, or hashes thereof, or obtain additional images such as a video sequence or a series of individual photographic images or hashes thereof, and/or evaluate the motions, positions, or other actions taken with the cell phone as part of the authentication process to determine what covert directions, if any, were being provided via a Private Rules configuration for the phone. The images (whether individual photos or video or both) and other inputs are compared with the personal rules for the authorized user to determine if any personal rules have been invoked and if so, the rules are interpreted and executed as directed. The evaluation of images and other data can be done through an online application hosted on a server in communication with the smart phone or other portable device, or by an application running on the smart phone or other or other portable device, or by a program running on a local computing device associated with the secured asset (e.g., a computer system securing an entrance of a building, elevator system, home, vault, vehicle, etc.), or by any combination thereof. A series of images such as 2 or more images may be obtained as a light pulses to indicate to the user when the images are being taken, to facilitate those embodiments in which a different in facial expressions or other body positions associated with gestures used for covert or overt cues.

To reduce the risks of spoofing or mimicking a user for facial recognition authentication, the system may employ a video CAPTCHA feature. Video CAPTCHA refers to an image-based CAPTCHA-like challenge and response system that can be used with facial recognition systems to verify that the image being captured is that of a living human and not a mask or animation, wherein the user is challenged to make facial expressions or motions in response to a query. Thus, the image display screen or GUI for a F.R. system may challenge the user to make a motion such as pursing the lips to confirm identity. The process of executing such an action provides an opportunity for the user to also include relatively covert actions such as first blinking with one eye, licking lips, slightly extend the tip of the tongue between the lips, wrinkling the nose, scratching an ear, straightening glasses, tilting the head, looking to the left, etc., while carrying out the requested facial expression or motion. For example, if requested by the system to smile for two seconds, the user may also squint while smiling in order to execute a provide rule to covertly select full or limited access, as specified in the personal rules. Alternatively a deliberate error of a predetermined kind could be employed such as looking to the right initially at least when the request is to look to the left.

The personal rules may be adapted to specify an emergency state which, when selected through a visual and/or verbal signal from the authorized user, generates a signal directing the security system to take an emergency response measure to protect the authorized user. In embodiments related to transportation, this may cause the vehicle to slow or experience apparent malfunctions, or may cause an emergency signal to be directed to police or other agencies, etc.

The security system may also comprise a training module adapted to periodically assist the user in practicing use of the personal rules to reduce the risk of failure. The training module may be accessible via a GUI when the user logs in to an administrative interface to select personal rules, including covert cues that may be provided during the user authentication process or during use of the asset following initial authentication and the responses that the covert cues are programmed to enact. The training module may also be accessible on demand from a login portal, a cell phone, or other tool, and may be prompted automatically by the security system either periodically according to a predetermined schedule or based on ongoing e valuation of the user's interaction with the security system in order to reduce the risk of failure or miscommunication.

The training module may allow the user to test the selected covert cues with a real or simulated authentication procedure or real or simulated use of the asset, thereby showing the user the difficulty of successfully conveying the selected covert cue and, if the risk of failure seems to high to the user or is beyond a predetermined threshold, either providing training to the user including guidance on how to better perform the covert cue or recommending modifications to the personal rules settings to change the covert cue to one more likely to succeed. An artificial intelligence system can evaluate user performance, characteristics, track record in past use of the security system, and security needs of the user to recommend covert cues that may be easier to remember, easier to perform, and/or easier for the facial recognition system or other user input systems to recognize accurately, considering the risks of both falsely recognized commands and missed commands. The training module may include video content delivered to the user showing past interactions with the security system to help the user understand how actions were interpreted and to confirm which interpretations were mistakes. The system may then highlight problems and, for example, provide computer-generated imagery to show the user how to make the attempted covert cue more successful, both in terms of being detected by the apparatus in question but also how to remain relatively covert or covert tor educe the risk of others recognizing that a deliberate cue is being provided.

In embodiments with automobiles, the transportation device is a vehicle equipped with a plurality of airbags, wherein the personal rules provide for identifying a companion of the authorized user as a security threat, and wherein an emergency response to the threat is selected from at least one of deploying an airbag near the companion, automatically bringing the car to an abrupt halt after driving has commenced, wirelessly sending a distress signal to authorities, and autonomously directing the vehicle toward a site proximate to police or other authorities.

In a related embodiment, a method is provided for protecting an asset comprising: providing a security system to protect the asset operatively associated with a facial recognition system comprising one or more cameras;

establishing a database of facial recognition data for one or more authorized users of the asset and optionally for one or more trusted companions of authorized users, wherein one or more authorized users of the asset are further associated with a Private Rules database providing personal rules directing a response of the security system to one or more cues provided via the facial recognition system and/or additional data input devices, said personal rules including one or more rules governing the response of the security system in the event of a covert cue from an authorized user indicating at least one of duress, an emergency, a criminal or security threat, and the presence of an accompanying party;

capturing one or more images of a prospective user from the one or more cameras of the facial recognition system;

determining whether the prospective user is an authorized user or trusted companion based on facial recognition analysis of the captured one or more images according to the database of facial recognition data;

in response to determining that the prospective user is an authorized user, determining if the authorized user is associated with personal rules in the rules database, and if so, comparing the personal rules with the one or more images previously captured and determining if the one or more cues specified by the personal rules have been provided by the authorized user to activate at least one personal rule, and if so, generating a signal directing the security system to implement the at least one personal rule, otherwise providing the authorized user with full access to the asset. The one or more cues may comprise a specific facial expression, hand gesture, audible sound, foot position, leg motion, assumed posture, etc., alone or in combination. If the prospective user is found to be a trusted companion, the Private Rules database is also checked to see if there are rules governing the particular person or trusted companions in general, and if so, implementing those rules. Such rules may include provisions for allowing the trusted companion to have full or limited access to the asset, etc.

In one embodiment, full access may only be provided if a covert cue such as a masked cue is provided during or near the time of authentication. The covert cue may be a specific facial expression or gesture. The Private Rules database may indicate specific steps to take in response to the lack of the specific expression or gesture. The response may be any one of limited access, deceptive access, alarmed access, and denied access, wherein in response to a selection of deceptive access, the security system is adapted to create the appearance that full access to the asset has been granted. Deceptive, limited, or alarmed access here may comprise inability to drive a vehicle, inability to steer a vehicle, autonomously driving to a location determined by the authorized user, feigning an out of fuel condition or vehicle malfunction and the like.

As used herein, “comparing” one or more images obtained from a camera in a facial recognition system with data in a facial recognition database may comprise transmitting one or more images or portions thereof from the database to the facial recognition memory and/or processor, or visa versa, but may also comprise first hashing the image obtained by the facial recognition system and transmitting the hash rather than the entire image in order to expedite transmission and comparison. Thus, comparing images may comprise comparing hashes of images. Obtaining a hash may comprise calculating many different parameters from an image or sequence of images that can correspond to facial features such as eye color, skin color, mouth width to nose length ratio, cheekbone width to eye width, forehead wrinkle parameters, radius of curvature of the chin, and so forth. An array or ordered list of the results can then be expressed and encrypted with tools such as bcrypt, Argon2, crypt, key stretching, PBKDF2 (Password-Based Key Derivation Function 2), scrypt and any other suitable tool that can yield a relatively short data string that contains adequate information for a meaningful comparison with a database.

In another embodiment, a smart vehicle such as a smart car is provided in operative association with one or more cameras and comprising a non-transitory computer readable media comprising directions for:

a) receiving one or more images from the one or more cameras of a prospective user seeking access to the smart vehicle;

b) comparing the one or more images to a database of facial recognition data for authorized users of the smart vehicle to identify the authorization level of the prospective user;

c) in response to authorization level of the prospective providing permission to use the smart vehicle, further determining if the user has entered personal rules in the non-transitory computer-readable media that specify security-related actions in response to user actions;

d) evaluating the one or more images and/or obtaining further images of the user and determining if a specified action has been performed to invoke one or more personal rules, and if so, executing the one or more involved personal rules by transmitting a corresponding signal to the smart vehicle.

In another embodiment, a security system for protecting an asset is provided comprising one or more cameras for viewing a prospective user of the asset, a barrier to access of the asset, and a non-transitory computer readable medium adapted to communicate with the one or more cameras and the barrier, the non-transitory computer readable medium comprising a facial recognition database, and a personal rules database, the system adapted to:

(a) receive one or more images of a prospective user seeking access to the asset;

(b) compare the one or more images of a prospective user to a database of facial recognition data related to authorized users of the asset to identify an authorized user;

(c) determine which personal rules have been established for the identified authorized user, and

(d) further analyzing the received image data and/or other input data during the authentication process or within a predetermined time apart from authentication to determine if a covert action according to the the user's personal rules has been entered during or near authentication, and

(d) transmit a signal to regulate the barrier to provide a degree of access to the asset according to the personal rules for the authorized user.

The degree of access to the asset as defined in at least one personal rule may include providing limited access, deceptive access, or alarmed access to the asset. The non-transitory computer readable medium maybe adapted to provide a graphical user interface to an authorized user providing for selection of personal rules with options displayed for using a facial recognition system to covertly request at least one of deceptive access, limited access, alarmed access, and denied access.

The non-transitory computer readable medium may be adapted to provide a graphical user interface to an authorized user providing for selection of personal rules with options displayed for at least three or at least four of: (1) providing full access to the asset, (2) providing deceptive access to the asset, (3) providing limited access to the asset, (4) taking emergency measures to protect the user from harm or loss, (5) preventing access by an accompanying party or group, (6) providing significant delay to the access, (7) adding additional barriers or burdens to overcome to gain access, and (8) denying access to the asset.

A related system may comprise an asset protected by a security system comprising a) at least one processor; b) at least one covert sensor; c) a memory comprising user-edited Private Rules providing instructions for providing access to the asset in response to an authorized user's Private Rules based on information received from the covert sensor which may be in addition to additional authentication data from an overt authentication device, and d) computer executable instructions readable by the at least one processor and operative to employ the at least one covert sensor to identify at least one covert gesture or series of gestures; and covertly trigger an alarm based on the at least one covert gesture or series of gestures, wherein the computer executable instructions are further operative to deactivate an alarm based on at least one gesture or series of gestures in a space; wherein in response to the triggered alarm access to the asset may be denied, feigned, or limited.

### Training and Retuning

In some embodiments, the security system is further adapted to periodically train an authorized user in the use of covert cues according to the user's personal rules. Further, the security system may be adapted to recognize weaknesses in the personal rules or missing rules of potential high value, and, to periodically prompt the user to consider revising existing rules or adding missing rules to enhance security. The user's performance in training sessions relative to remembering and executing the personal rules may be used as one indicator for the possible need to revise the rules that can be considered in making recommendations for improvements to the user. The training, testing, and prompting can be done through an app on a smartphone or other electronic device, or at a fixed or mobile portal or kiosk for users of the security system.

The user-defined personal rules can be prepared using a rules selection interface operatively associated with the security system of the protected asset, in which a rules selection system provides tools for user selection of additional actions including cues provided through the facial recognition system that go beyond merely identifying the user (or merely confirming the identity and living nature of the user). When rules for an authorized user have been established via the rules selection interface, they can be stored on a secure personal rules database or other suitable non-transitory computer-readable medium in communication with the security system. Such cues can be covert actions (e.g., subtle actions that may be difficult for an observer to recognize as a planned entry to convey a message or request for action) involving a gesture, series of facial expressions, etc.

The rules selection interface can provide selections for security actions to implement in response to user-selected expressions, gestures, or other cues, such as (1) providing full access to the asset, (2) providing deceptive access to the asset, (3) providing limited access to the asset, (4) taking emergency measures to protect the user from harm or loss, particularly while in a state of apparent duress or under threat from a potential criminal, (5) preventing access by an accompanying party or group, (6) providing significant delay to the access (e.g., overly providing notice that the asset is unavailable for a minimum time threshold of, say, at least 5 minutes, 15 minutes, 30 minutes, an hour, or any integral number of hours or number of minutes from 1 to 300 inclusive), (7) adding additional barriers or burdens (real or deceptive) to overcome to gain access (e.g., overly stating that further verification by a third party at a remote location is needed before access can be provided, stating that a fee is due of any arbitrary amount and must be paid before accessing the asset, stating that there is a legal barrier to access requiring resolution by legal authorities, or stating that a hardware malfunction prevents access until a replacement part is received, etc.), and (8) denying access to the asset. The rules selection interface may provide all 8 of the above-listed selection classes, or at least 3, at least 4, at least 5, at least 6 or at least 7 of the above-listed selection classes.

The security system can also be used to protect a cell phone. Facial recognition systems already are available on iPhones , for example, that can be used to recognize and authorized user and unlock the phone or make a payment. However, further security can be provided by adding systems responsive to private rules in which facial expressions or series of facial expressions can be used to activate previously registered personal rules. In response to the personal rule(s) activated, one of several security states may be selected. For example, normal full access may be provided. Depending on the presence of or lack of specific facial gestures, full access to all functions and apps may be provided, but additional entry of credentials may be required to access certain functions such as making a payment, accessing a financial account, or reading email or email in certain folders or from certain senders. This can be described as “full phone access with security requirements.” In other cases, access may only be provided to certain apps and functions, and prohibited apps may be invisible, locked, or respond with feigned failure or automatic closure, as if beset with a bug or out of memory condition. In some cases, access to functions that alter the security status of the phone may be blocked or feigned.

Inventive Scenario 2: An iPhone user is approached by an armed thief and told to hand over his iPhone, but first he is told to enter his password, then go the phone's settings and remove password protection and also turn off the “find iPhone” feature. The user complies by looking at the phone with a facial expression lacking a smile, unlike the full smile his personal rules setting requires for normal full access to the phone. The smile-free face activates a personal rule that provides only feigned or limited alteration of passwords, location tracking, etc., prevents opening of a bank app with an account closed error, and limits any other payments to under $30. After feigned removal of a password, when the phone is locked again, it will unlock without a password, staying in the same security state. Meanwhile, the phone is recording and transmitting information about the theft and has alerted an administrator of the theft in progress. Tracking will remain in effect and the phone can be wiped, locked, or take other measures depending upon later actions of the user or a trusted administrator following predetermined protocols.

Various embodiments described herein may incorporate movement detection circuitry to identify the motion and/or position at various times of an object such as a portion of a human body, an item of clothing such as a shoe, a pant leg, a sleeve, a tie, car keys, an ID badge, a gate pass, and the like. Such circuitry and related systems are discussed, for example, in US Patent App. No. 20080134102, published Jun. 5, 2008, by C. Movold et al., who describe systems using a variety of motion detecting systems such as cameras, IR detection devices, ultrasonic motion detectors, etc.

“Corporeal actions” include motions made with the body that can be recognized by automated systems such as facial recognition systems, gait recognition systems, arm gesture recognition systems, and the link. Gestures with hands, fingers, arms, or other body parts may be considered, as well as facial patterns, body stances, modes of walking or movement including motions from dance, transitions from one pattern or gesture to another, and the like all may all be used to convey hidden cues. In one embodiment, the corporeal actions include a first motion that is meant to be overt and thus easily recognized by others as a deliberate action being made by the credential bearer. This overt action may be superfluous or may be required as part of the authentication process. The overt action may be accompanied by (i.e., done simultaneously with or shortly before or after) another physical action that is relatively covert.

“Relatively covert” as used herein to describe a physical action in comparison to the overt physical action, indicates that the latter tends to mask or distract from the former such that onlookers seeking to see how the credential holder gains access to an asset and suspecting that physical actions may play a role, are likely to be misled into thinking they understand that the particular over physical action is required, while missing the relatively covert gesture or gestures or series of gestures including one or more relatively covert gestures that may be required for full access. If credentials are provided by another party that includes all required credentials (e.g., a password, a physical key or access card, etc., plus the overt physical action) except for the relatively covert physical action, the system can, according to the private rules established for the credential holder, respond with limited access, feigned access, denied access, an alert, or other requested actions.

### Definitions

As used herein, a protected “asset” can include a tangible device or physical setting or location. Such items may include an automobile, boat, airplane, drone, military vehicle or other vehicle; a safe or lockbox or other container; an ATM machine or other financial-related kiosk or machine; a home; a secure doorway or container with a door such as a secure refrigerator; a lab or other secured room; a gated community; an office; a business such as a shop, warehouse, factory, or other building or facility; a vault or safety deposit box; a computer, tablet, cell phone (e.g., unlocking the cell phone or authorizing its services), or other electronic device; a limited or ticketed event or service such as access to a seat on a train or plane or entry into a theatre or amusement park, etc., and various machines, tools (e.g., smart glasses, medical equipment, etc.), weapons or weapon systems, communication devices, etc. The “asset” may also involve use of a physical object linked to financial instruments or other valuables, such as the use of a physical credit card, cell phone for payments or other transactions; a printed ticket or coupon or printed securities; a passport including “smart” passports with embedded chips for wireless communication or other forms of tangible ID; printed receipts and certificates; books including accounting books; keys to vehicles, rooms, or other devices; etc. The protected “asset” may also refer to electronic accounts and digital assets such as a bank account, a credit card account, a brokerage account such as Etrade; an online e-commerce platform such as Ebay, Taobao, and the like; payment tools such as PayPal, Alipay and WeChat; social media tools such as WeChat; virtually any app or website requiring some level of user authentication; network security systems; corporate Intranet services; wifi access; tools for delivering secure document such as BotDoc.io; tools for storing documents and files such as iCloud, Google Drive, and DropBox; email accounts in general or access to email systems on electronic devices; and so forth.

As used herein, a “user authentication” system can sometimes be used substantially interchangeably with “user identification” system, although authentication generally infers something more than merely identifying a user, but also recognizing the appropriate level of access to an account, device, or other asset that the identified user is entitled to. Identifying a trusted user need not be sufficient to grant access, but rather additional levels of verification of the perhaps tentatively identified user may be required. User authentication systems may apply a variety of means for receiving user credentials or identifying a user, including passwords, biometrics data such as facial recognition data, and so forth. See, for example, U.S. Pat. No. 7,769,207, “System and method for collection, storage, and analysis of biometric data,” issued Aug. 3, 2010 to J. W. Olivo Jr., et al.

As used herein, a “facial recognition” system refers to hardware and/or software adapted to acquire or receive an image that may contain the image of a human face, wherein the system can recognize that a face is present, can identify its characteristics and then compare its characteristics to those in a database or a memory and thereby determine which if any of the faces associated with the database are most likely to be the face in the acquired or received image, and/or determine if the acquired or received image is likely to match a particular face of interest, optionally providing one or more measures of confidence for any pairings considered. The systems disclosed herein can employ any suitable facial recognition system, including hardware and software therefor. Facial recognition methods and systems are described in U.S. Pat. No. 6,301,370, “Face recognition from video images,” issued Oct. 9, 2001 to J. B. Steffens et al. The '370 patent describes an apparatus and method for detecting and recognizing a head or face in an image frame. The identification and recognition process uses an image processing technique based on model graphs and bunch graphs that efficiently represent image features employing wavelet transforms, processed at nodes or landmark locations on an image corresponding to readily identifiable features. Facial recognition systems can be adapted to recognize static images, a series of static images, video images, and so forth. Recognition of video images is discussed, for example, in Baoxin Li and Rama Chellappa, “A Generic Approach to Simultaneous Tracking and Verification in Video,” IEEE TRANSACTIONS ON IMAGE PROCESSING, 11/5 (May 2002). Further details for facial recognition systems are found in M. Turk and A. Pentland, “Eigenfaces for Recognition”, Journal of Cognitive Neuroscience, vol. 3, no. 1, pp. 71-86, 1991; Wenyi Zhao et al., “Face recognition: A literature survey,” ACM computing surveys (CSUR), 35/4 (2003): 399-458; and N. H. Barnouti et al., “Face Recognition: A Literature Review,” International Journal of Applied Information Systems (IJAIS), 11/4 (September 2016). Software packages for facial recognition include the FACE++ Al Open Platform (www.faceplusplus.com/) of APIs and SDKs for learning-based image analysis recognition technologies.

Further examples of facial recognition systems are described in US Patent Application 2007/0291998, “Face authentication apparatus, face authentication method, and entrance and exit management apparatus,” published Dec. 20, 2007 by Takizawa et al.; United States Patent Application 2006/0026427, “Method and system for entity authentication using an untrusted device and a trusted device,” published Feb. 2, 2006 by S. T. Jefferson; U.S. Pat. No. 8,457,367, “Facial recognition,” published Jun. 4, 2013 by M. A. Sipe et al.; US Patent Application 2012/0075452, “Controlled Access to a Wireless Device,” published Mar. 29, 2012 by B. Ferren; U.S. Pat. No. 8,064,688, “Object recognizer and detector for two-dimensional images using Bayesian network based classifier,” published Oct. 28, 2008 by H. Schneiderman; U.S. Pat. No. 7,689,033, “Robust multi-view face detection methods and apparatuses,” issued to R. Xiao et al., Mar. 30, 2010; all of which are hereby incorporated by reference in their entireties to the degree they are not contradictory with the present disclosure. Facial recognition systems that can be adapted for use with the systems and methods of the present disclosure may also include any known commercial systems, both hardware and software, such as systems provided by L-1 Solutions (Stamford, Conn.), Yitu Technology (Shanghai, see http://yitutech.com/en/), Apple, Facebook, Amazon, Cognitec (Dresden, Germany, http://cognitec.com/), SenseTime (Shanghai, China), Megvii (Beijing), etc.

In some embodiments, the images acquired for F.R. are taken by a depth camera, also called a depth sensing camera. In general, a depth camera provides a sequence of distance, or depth, images of objects in the field of view and may emply structured-light, active or passive stereo, or time-of-flight cameras which may, for example, obtain images by video recoding with a frame rate of at least 5 frames per second (fps) with both image data (color or gray scale values) and depth values recorded for each pixel. Depth information may be characterized as distance from the camera to an object or may indicate whether a pixel is closer or farther from a specified reference value, etc. Methods for obtaining facial data with depth cameras are discussed in U.S. Pat. No. 10,157,477, “Robust head pose estimation with a depth camera,” issued Dec. 18, 2018 to S. E. Chen. Related hardware and software is marketed by Bellus 3D, such as the Bellus 3D ARC (Campbell, Calif.), which is said to offer the ability to rapidly obtain 3D facial data which can be used to print 3D faces on suitable 3D printers. (Note that while such systems and the data they create can elevate the risk of thieves using 3D masks or 3D video imagery to mimic a user in a F. R. system, the addition of the security features described herein enhanced with Private Rules can greatly reduce such risks and give users customized, robust security to defeat many threats.)

As used herein, “gesture recognition” refers to image recognition systems that may include facial recognition systems, wherein motions made by a human can are detected by systems comprising cameras that capture the motion of the gesture and determine the aspects of the motion. Examples of gesture recognition technology include U.S. Pat. No. 5,798,758, “Gesture-based data processing method and apparatus,” issued to T. Harada et al., Aug. 25, 1998, which aims to improve the operation of a command designation by notifying previously input gestures and allowing a user to re-use the previously input gestures with simple operations. In order to achieve the above objects, a gesture display area for displaying previously input gestures and commands is formed on a display screen, and if the gesture display area is designated, the command corresponding to the designated gesture is executed. Gesture recognition may also draw upon the discussion in U.S. Pat. No. 8,457,353, “Gestures and gesture modifiers for manipulating a user-interface,” issued Jun. 4, 2013 to B. Reville et al.; U.S. Pat. No. 7,593,552, “Gesture recognition apparatus, gesture recognition method, and gesture recognition program,” issued Sep. 22, 2009 to. N. Higaki et al. The '552 patent describes a gesture recognition apparatus comprising a face/fingertip position detection means that detects a face position and a fingertip position of a person in 3D space based on contour information and human skin region information of the person to be produced by the images captured; and a posture/gesture recognition means which operates to detect changes of the fingertip position, to process the detected results by a previously stored method, to determine a posture or a gesture of the object person, and to recognize a posture or a gesture of the object person. Also to be considered are the gesture recognition methods and hardware of US Patent Application 20100185341, “Vehicle Mode Activation by Gesture Recognition,” issued Jul. 2, 2010 to T. A. Wilson et al.; U.S. Pat. No. 7,898,385, “Personnel and vehicle identification system using three factors of authentication,” issued Mar. 1, 2011 to R. W. Kocher; U.S. Pat. No. 9,721,408, issued to K. Obata Aug. 1, 2017; U.S. Pat. No. 9,256,779, “Gesture recognition apparatus, gesture recognition method, and recording medium,” issued Feb. 9, 2016 to K. Obata; U.S. Pat. No. 7,710,245, “Security system for a motor vehicle,” issued May 4, 2010 to C. A. Pickering et al.; and U.S. Pat. No. 10,166,995, “System and method for feature activation via gesture recognition and voice command,” issued Jan. 1, 2019 to B. Beauvais. Further details are provided in L. R. Rabiner, “A tutorial on hidden Markov models and selected applications in speech recognition,” Proceedings of the IEEE, vol. 77 (1999): 257-285, where the Hidden Markov Model approach can be useful in recognizing hand or facial gestures, sounds, and so forth. Software packages for gesture recognition include the FACE++ Al Open Platform (www.faceplusplus.com).

As used herein, “personal rules” refer to user selectable and/or user editable rules that govern the response of a system protecting an asset, including details to define the nature of limited access, deceptive access, alarmed access, or denied access, in response to providing user credentials such as a password, identify verification via facial recognition or other biometric means, and so forth. Likewise, “Personal Rules” is generally synonymous with “personal rules,” although Private Rules are understood to comprise be part of a system in which a user can provide covert cues to convey commands regarding the security and/or performance of a protected asset, and in which a user can, via a graphical user interface, for example, edit the rules for one or more contemplated situations to select actions to be taken or security limitations to be imposed in response to providing a predetermined covert cue. Principles for personal rules and Private Rules, their storage in memory, their editing via a user interface, and related information is disclosed in U.S. Pat. No. 7,552,467, issued Jun. 23, 2009, and U.S. Pat. No. 9,959,694, issued May 1, 2018, with further advances described below.

As used herein, a “secondary password” is a password or user authentication credentials that, for a given user, provides less than full access to a protected asset, and typically provides substantially limited access or may provide deceptive access. In contrast, a “primary password” can be considered as credentials that, for a given user, provides full access to the protected password. Generally, a primary password provides the highest level of access normally available to the user for a particular mode of access. In a facial recognition system for protecting access to an asset, the display of the user's face with a hidden or covert action such as wrinkling the nose and twitching the lips immediately before, after, or as a flash of light occurs or the user presses a button to send the currently displayed image, thus (covertly) acquiring a facial image, can cumulatively be considered to comprise providing a primary password, if so designated in the user-editable Private Rules associated with the protection system of the asset, or may be used to define a secondary password that prevents full access and may provided limited, deceptive, or alarmed access to the asset.

As used herein, a “designated assistance site” is a known location where a user in duress can obtain assistance or be rescued. This may include a police station or other public authorities, a location run by or designated by a commercial security service, a location listed in a database associated with a Personal Rules system or a server associated with the security systems described herein, etc. In some cases it may include a public place where assistance from the public can be sought.

### BRIEF DESCRIPTION OF THE DRAWINGS

FIG. 1 depicts an automobile with a graphical user interface projected on a window in operative association with the a recognition system protecting the vehicle and the user's personal rules configurations.

FIG. 2 is a flow chart showing the use of personal rules configured with a security system comprising facial recognition tools for protecting an asset.

FIG. 3 depicts hardware and non-transitory computer-readable memory configured to respond to personal rules invoked through use of a facial recognition system and verbal signals.

FIG. 4 is a schematic of an authentication portal comprising an upright structure containing a display screen in which a covert camera may be used to obtain covert cues from a user when using a F.R. system for authentication.

FIG. 5 depicts a facial recognition-based security method involving a facial recognition system in which facial images are converted to a hash and in which a covert input system acquires additional input from a user to convey covert cues to be interpreted according to the user's predetermined Private Rules configuration for enhanced security for a protected asset.

FIG. 6 depicts an asset protection system that comprises a Private Rules module 142 and a biometrics module with interact with an asset control unit.

FIG. 7 is a schematic of a fob and its method of use in protecting an asset with a vehicle access and control system that relies upon a facial recognition system and a Private Rules system responsive to covert cues from facial recognition or other input systems.

FIG. 8 is a schematic of the various modules and hardware systems of some embodiments of a security system in which facial recognition system and a personal rules system cooperate to enhance the security of a secured asset, in particular showing interactions of various components with or via a communications module and the role of a training module to reduce the risk of error when providing covert cues.

FIG. 9 shows an automobile door adapted to cooperate, in protecting access to the interior of the vehicle, with both a facial recognition system and a password entry device.

FIG. 10 is a schematic showing the use of a fob or other electronic device that can convey biometric information to a security system for protecting an asset (not shown) with options for customization and use of covert cues according to a Private Rules feature.

FIG. 11 shows an exemplary user interface for customization of Private Rules in a security system with options for providing covert cues via a facial recognition system, wherein customization features for a training system for use of Private Rules is also provided.

### DETAILED DESCRIPTION

Systems and devices in the present disclosure may comprise a facial recognition system operatively associated with a processor and memory comprising user-defined rules (“Private Rules”) to provide full, deceptive, or limited access to an asset. The asset is associated with the facial recognition system but may also require entry of a password, use of a key card or other authenticating device, or other user authentication systems or user identification systems.

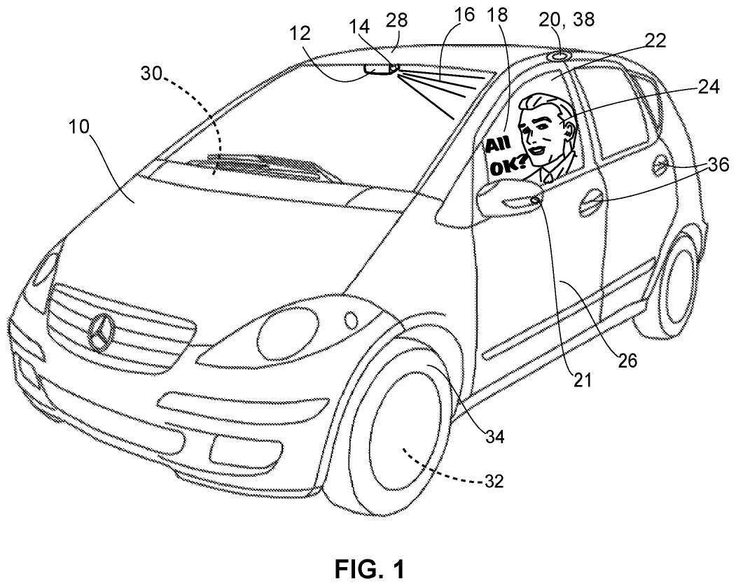

FIG. 1 depicts an automobile 10 comprising a security system with a control module 12, here shown connected to a video projection system 14 for projecting light 16 to display an interactive graphical user interface 18 onto a window 22. Alternatively, any suitable image control system could be employed, including electronic controls for an LED plasma, a electric ink display, a pop-up screen inside the car or on its outer surface, or other electronic display attached to or operatively associated with one or more windows or externally visible portions of the automobile. In a related embodiment, the GUI 18 may comprise an image projected to a user's cell phone or other image receiving device such as a screen on a smart watch worn by the user or a key fob carried by the user. The GUI 18 may employ a user-selected avatar 24 to represent the security system and the autonomous driver of the automobile 10 for those embodiments in which the vehicle is an autonomous guided vehicle (also termed “self-driving car” or “driverless vehicle”).

In the embodiment shown, the control module 12 is mounted on the ceiling under the roof 28 of the automobile 10, though it could be integrated with other control systems or disposed in any suitable location or plurality of locations. The control module 12 is in communication with one or more cameras 20 mounted on the automobile for observing and identifying individuals approaching the automobile. Additional devices 38 such as microphones and speakers may be installed on the automobile 10 to facilitate interaction with the graphical user interface 18.

The control module 12 may optionally be in communication with other cameras such as those near the automobile 10 in a parking facility or a camera in a user's smartphone (not shown) that can communicate with the control module 12 prior to or while approaching the automobile 10.

The control module 12 comprises or is associated with a non-transitory computer-readable medium that can process images received from the one or more cameras 20 providing images of an approaching individual to determine if the individual is an authorized user by comparing the received images to a facial recognition database and optionally a gait measurement database. The non-transitory computer-readable medium may also comprise a personal rules database prescribing security-related steps to take in response to specific user commands provided by an authorized user by providing certain facial expressions or series of facial expressions, or gestures or series of gestures, or any combination thereof, to regulate the level of access to be provided to the user and/or companions or others, and if needed to initiate specific actions such as emergency rescue, mitigating threats, alerting police, seeking medical assistance, etc. Thus, in response to providing a recognized and possibly covert or relatively covert input through the facial recognition system via the one or more cameras 20 or via other devices 38 associated with the graphical user interface 18, the authorized user can provide a variety of directions to limit the level of access, provide deceptive access, direct emergency or rescue operations to take place, seek external assistance, etc., as determined by directions on the non-transitory computer-readable medium of the control module 12 according to the personal rules associated therewith and the input of the authorized user.

The automobile 10 is also adapted to make emergency responses or take other security steps in addition to simply denying entry to the vehicle or refusing to start the engine or drive. Emergency responses to mitigate the threat of a potentially dangerous party inside the vehicle can include deploying an airbag such as a passenger side airbag 30 installed in the console of the vehicle (not shown) or rear seat airbags (not shown). It can also include locking seatbelts (not shown) or tires 34 with air-releasing mechanisms 32 that can quickly reduce air pressure in a tire 34 on demand to simulate a flat tire. Other related security measures can include locking the doors 26 such that door handles 36 are inoperable to either prevent a passenger from getting out to pursue the fleeing authorized user or to prevent entry from an unauthorized party. They can also include simulating a low-gas situation, pretending to run out of gas, simulating mechanical trouble or failure necessitating a stop or rapid deceleration, suddenly stopping preferably with the aid of an ABS braking system, swerving violently, and autonomously driving (overriding the steering of a human driver) to a more secure location.

The system of FIG. 1 can be used in Inventive Scenario #1 above. Thus, when an authorized user has been identified to be in the presence of one or more unrecognized companions, when the user provides covert input through specific facial recognition cues to the one or more cameras 20 or input to the graphical user interface 18 through other sensors 38, a command according to the user's personal rules may be recognized calling for emergency assistance in a duress situation, and thus one or more of the emergency capabilities of the automobile may be deployed at a suitable time.

The user-defined (or default) personal rules associated with the control module 12 can be prepared using a rules selection interface (not shown) that may be available via a related app on the user's cell phone, via a website, at a kiosk or computer system at the automobile dealership, etc. The rules selection system, provides tools for user selection of additional cues through the facial recognition system that go beyond merely identifying the user (or merely confirming the identity and living nature of the user). The additional cues represent further secrets that the user can enter with relatively low risk of others knowing that such secrets have been conveyed, and in response to entry of these secrets through a facial recognition system and/or associated additional user identification/authentication systems involving other sensors 38, the user can control how the asset security system responds. The personal rules system allows the user to control when the security system provides 1) full access to the asset, 2) limited access to the asset, 3) deceptive access to the asset, 4) denied access, and optionally 5) options for emergency or special measures, typically with covert cues to control the system.

In automobiles and other vehicles such as those in FIG. 1, the one or more cameras in operative association with the facial recognition system can also include cameras inside the automobile 10, such as a rear-mounted camera that can observe a driver's face via a rear-view mirror, as shown in U.S. Pat. No. 7,602,947, “Facial Recognition Vehicle Security System,” issued Oct. 13, 2009 to Jeremy Lemuelson. In one embodiment, a vehicle can include a camera mounted on a “third taillight” assembly which may be mounted below the roof and inside the rear window, directed at a rear-view mirror, and coupled to a facial-recognition computer, which in turn is coupled (with appropriate security precautions) to an enabling element for the vehicle, such as a starter motor and/or the transmission and braking systems, power train, battery, fuse system, computer, etc. In a further embodiment, the system can be coupled to various elements of the motive system for automatic starting.

In some embodiments, the security system also includes training modules operated and scheduled by the control module 12 or other memory associated with the security system. The training modules assist or guide the user in properly implementing the selected rules, thereby ensuring that the user remains aware of the options and appropriate responses to cope with changing circumstances or possible emergencies. Interactive training with periodic training and tests can be helpful in making the system remain useful for the user. Thus, in the embodiment of FIG. 1, for example, the avatar 24 of the graphical user interface 18 may periodically recommend that the user conduct a simulation of various situations to test her ability to activate the rules through appropriate cues. When certain rules are found to be poorly remembered or performed, the control system may recommend changes to more easily remembered rules and then conduct periodic training to ensure that the altered rules are remembered and properly used.

In one embodiment, after gaining access to the automobile 10 but before are after driving it or using it for any substantial tasks, the training module may use video, voice, or other tools to simulate a particular scenario such as the threat of a hijacker, or permitting another person such as a relative or friend to use the asset. The training module may assist and train in implementing the user's predefined personal rules (or Private Rules) for various scenarios that may involve displaying or entering covert cues, and works to ensure that the user can carry out the appropriate rules for a given scenario and variations of those scenarios. The training module may also provide an override method to allow the user to postpone training until more convenient, as well as a training request feature to provide training and testing on demand. Thus, the training module may evaluate and track performance, initiate training, provide user feedback and scoring from test sessions and actual performance, simulate scenarios and test user responses to confirm that the user can execute Private Rules settings when needed, and allow override of automated testing. Further, the testing module may propose alterations to personal rules to overcome problems the user encounters when forgetting a required cue or executing the cues poorly. Through such an iterative approach, the user can be better prepared for various scenarios and have rules that suit the system and the user.

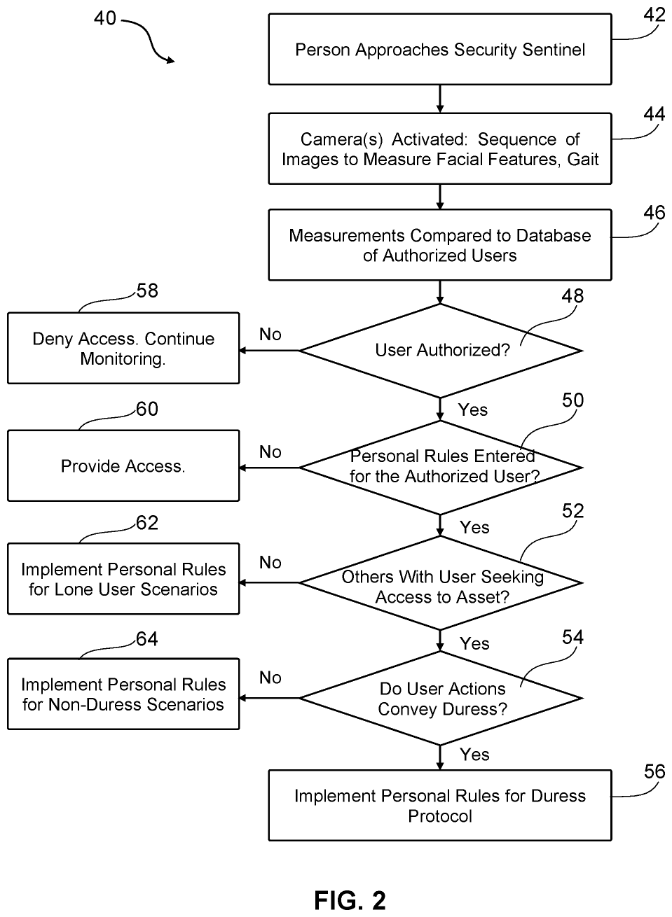

FIG. 2 is a block diagram depicting a security method 40 in which a person approaches a security sentinel 42 (e.g., a portal, a gate access point, etc., with a facial recognition system and associated hardware and software for implementing personal rules for authorized users responsive to cover cues made with facial expressions or gestures, etc.). Cameras are activated and a sequence of photographs or video frames is obtained and measurements are made to determine facial data and optionally gait data 44, and the measurements are compared to data for authorized users 46 to determine if the person is an authorized user 50. If not, access is denied 58 and monitoring continues. If authorized, then the system queries to see if personal rules have been entered into the system or in memory associated therewith for this user 50. If not, ordinary access is provided 60.

If personal rules are available, the system determines, based on recently acquired images, if there appears to be other people accompanying the authorized user who are seeking to also obtain access to the asset 52. For example, this could be a companion who may enter a car once the doors are unlocked, or someone accompanying a user into an elevator that may provide access to a secure floor. If no others are likely to gain access with the user, then personal rules for lone user scenarios can still be implemented 62. But if others pose a risk to also gain access to the asset, then according to the personal rules and optionally additional heuristics, the facial recognition data and other available data are scrutinized to determine it the user may be under duress 54. Has the user provided a cover cue such as a predetermined facial expression or gesture indicative or duress? Is there a verbal or other cue to that effect? Do physiological indicators such as signs of perspiration, facial features indicative of stress, etc., indicate possible duress? If intentional cues indicative duress according to the personal rules, then those rules should be implemented according to a predetermined duress protocol 56. Other factors indicative of possible duress may trigger an additional delay or a query of the user or a request for further validation to provide additional opportunities to provide covert cues regarding duress, or to assess that duress is not present. If it appears that duress is not present, the personal rules for a non-duress protocol should be implemented 64. The duress protocol may include alerts to police or security personal, intentional system problems that result in apparent mechanical failure or blocked access to the asset, emergency rescue or escape methods, limited or feigned access to the asset, etc.

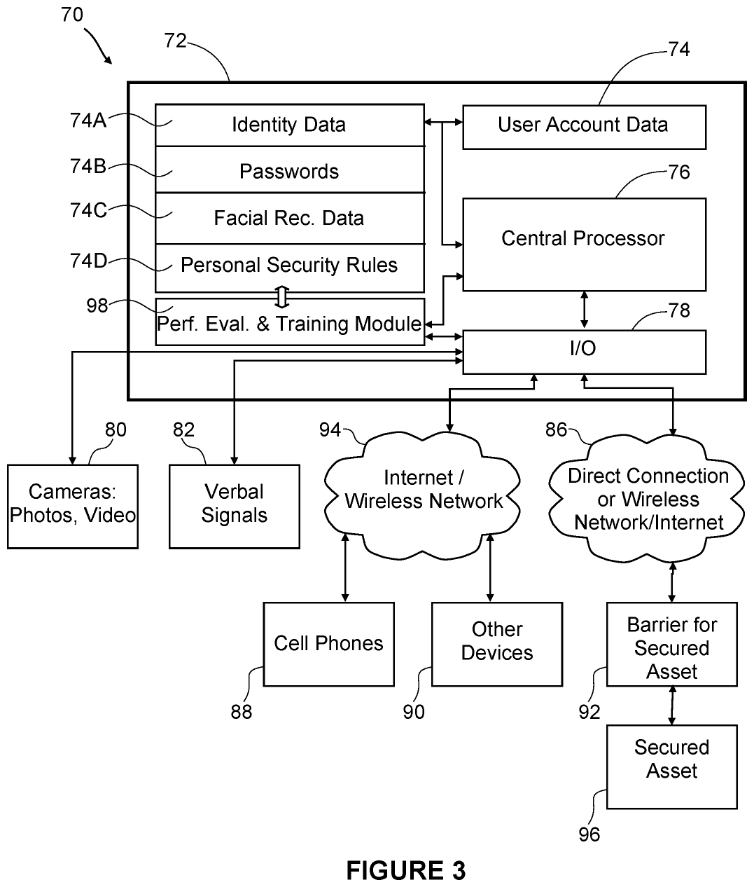

FIG. 3 is a block diagram depicting objects involved in a security system 70 involving facial recognition and personal rules, including a central system 72 comprising user account data 74 readable by a central processor 76 operably associated with an I/O device 78 for communicating with other objects and systems. The system is computer implemented with hardware and non-transitory computer-readable memory configured to respond to personal security rules 74D invoked through use of a facial recognition system and verbal signals 82. The user account data 74 may include private account information and records comprising identity data 74A (e.g., user account numbers, user name, user address, user telephone numbers, Social Security number, etc.), passwords and related credentials 74B, facial recognition data for authorized users 74C, and personal security rules 74D for authorized users. The security rules 74D can be provided as directions through the central processor 76 to govern the degree of access it permits relative to an asset (not shown). The I/O system 78 can receive information from any kind of cameras 80, plus devices for audio input to receive verbal signals 82. Information from cell phones 88 and other devices 90 such as biometric scanners for fingerprints, etc. can be received over the Internet of wireless networks 94. The I/O device is in communication with a barrier for secure access 92 to the secured asset 96, such that when images received are sufficient to authenticate a user and, based on received data in light of the personal rules 74D, some level of access to the asset 96 should be provided, then the I/O system 78 sends a suitable signal to the barrier 92 instructing it to provide the appropriate level of access to the asset 96. The access level can be full access, limited access, feigned access, access with a security alert or emergency protocol in effect, etc. In some embodiments, a unique facial expression or series of expressions or unique gesture or series of gestures or combination thereof is needed for the user to be granted full access to the asset, and when the unique expressions or gestures are absent, a lesser or feigned level of access may be provided, or denied access may be provided.

A performance evaluation and training module 98 interacts with the personal security rules (Private Rules) 74D, the central processor 76, and various inputs received through the I/O system 78 to determine if the user requires further training to accurately and appropriately use the personal security rules 74D and any associated covert cues (not shown) that may be specified for various scenarios or purposes. The personal security rules 74D may also specify when regular or periodic training is to be conducted, and may prompt the user to modify settings in the personal security rules 74D to be more compatible with the user's abilities and needs. For example, overly complex gestures and/or facial expressions required for certain situations such as duress may be more likely to fail and thus the system can prompt the user to consider selecting easier covert cues to achieve the intended level of security with reduced risk of failure in actual use.

In the security system 70, the central processor 76 may govern acceptance of user credentials presented by any means to the central system 72, including interpretation of user credentials in light of facial expressions or other covert cues provided by the authorized user according to the security rules 74D.

The security system 70 may be used to protect a vehicle, an electronic account, a physical structure such as a safe, building, or secure room, etc. In some embodiments, the facial recognition system is associated with an obvious user authentication portal, barrier, control system, or other system that is easily recognized as a figurative or literal gateway to access an asset. In other embodiments, the facial recognition system and the associated security system may not be evident. For example, a surveillance camera, whether hidden or visible, at the entrance of a bank or other place of business may not be associated with any obvious barrier to entry or other security features, but may nevertheless be part of a system that allows employees or other authorized users to convey subtle clues related to security as they approach, enter, or leave the building, and thereby initiate specific actions or security settings according to their user-selected rules. Thus, an employee entering under duress with an armed robber behind him may make a facial gesture or other body motion or sequence of gestures or motions detectable by one or more cameras that can trigger silent or audible alarms, initiate warnings, lock down a vault, simulate a power outage, and so forth to enhance security in a high-risk setting. The same can be done with an automobile or other vehicle, allowing control over access and response of the vehicle without letting nearby parties even know that facial recognition clues have been passed to a security system, or without even letting them know that a facial recognition system exists for the vehicle. The ability to do this can be provided through the administrative interface to a Private Rules system (discussed further below), although approval from administrators may be needed to allow certain actions to be selected as possibilities.

In addition to the facial recognition system within the security system 70, there may be one or more additional user authentication or identification systems (not shown). Such additional user authentication or identification systems can include entry of a PIN or password by keystrokes, PIN pad entry, finger swipes, image drawing, and so forth; voice recognition; gait recognition; wireless authentication systems such as RFID, NFC (Near Field Communication), SMS or other cell phone communication methods, including fobs or keys that communicate wirelessly with an authentication system governing access to a device or account.

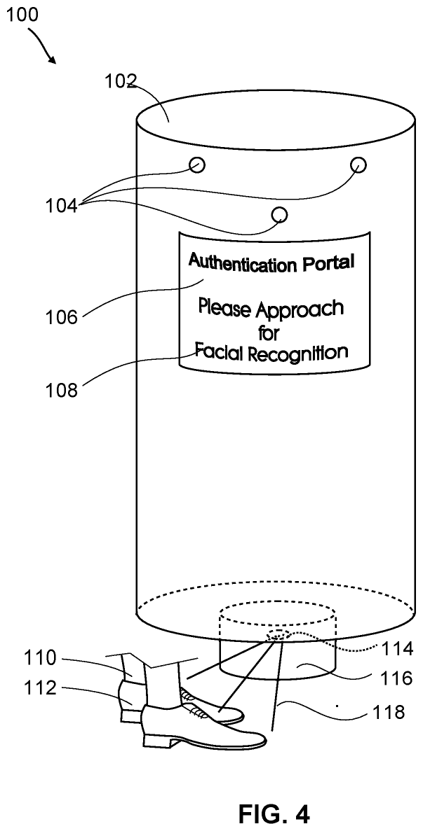

FIG. 4 illustrates an authentication portal 100 comprising an upright structure 102 containing a display screen 106 that may be a touch screen capable of receiving user selections and providing information. The portal 100 can receive user input with an overt facial recognition feature comprising one or more overt cameras 104 for viewing user and recognizing their identity by compared a quantified or hashed image to facial recognition database information (not shown) to recognize and individual and to then look up user settings in a Private Rules database (not shown) to determine if covert cues may be used to guide further steps. The display screen 106 may provide indicia 108 instructing users to approach for identification based on or including facial recognition (other methods can also be used in addition to facial recognition, such as the use of a personal card such as a credit card, a password entered on the screen or a keyboard (not shown) or by voice or other means, etc.

Covert cues may be obtained through a variety of means, including the use of a covert camera 114 mounted on a lower support structure 116 where its presence may be difficult to note. The covert camera 114 has a field of view 118 that can obtain images involving feet, shoes 112, and legs 110, and a related gesture recognition system can determine if positions or actions of feet, shoes 112, and legs 110 correspond with settings in the Private Rules database (not shown) for the user.

Inventive scenario 3: Sandra's sister Marlow is coming to town and would like to borrow Sandra is on a business trip to Indonesia. Sandra agrees and opens her First Cosmic Smart Car app and send an invitation to Marlow to register as an authorized driver/passenger of the autonomous smart car. Marlow receives an encrypted invitation via an encrypted Botdoc digital container via Botdoc.io, which runs a Smart Car Guest User application that directs Marlow to user her smartphone or other device to take images of her face from several angles, either as photographs or a movie as she moves the phone to various positions. Images in various lighting conditions and with and without glasses, hats, scarves, etc. may also be requested to build a suitable database for precise recognition. Voice input may also be requested to provide for voice recognition, and a movie of Marlow walking to, from, and in front of the camera in her smart phone or other device may also be requested. After images and other needed data have been uploaded, a representative image or series of images are provided to Sandra for final authorization for Marlow to use the car, along with selections to determine what functions, privileges, and limits may apply to Marlow's usage (e.g., additional guests or pets not allowed without Sandra's permission, permission for only 3 days and only for trips within 200 kilometers of home unless authorized by Sandra, speeds over 120 km/hr not allowed, and granting the ability to select customized security rules, etc.). Once Sandra has authorized Marlow as a user, the Smart Car Guest User application may allow Marlow, if so authorized by Sandra, to select customized security rules regarding her use of the car, including the ability to have a duress code in the form of a facial gesture, body gesture, or voice command which will notify police of a duress situation and, for example, adjust the gas gauge to show nearly empty, force the car to stall shortly after driving commences. Alternatively, the selections may specify that under duress, the vehicle can travel at a speed no more than 40 km/hr and automatically drive it to the nearest designated assistance site such as a police station in response to yet another verbal or facial cue. Options may also be provided for automatic autonomous driving to a suitable hospital or clinic in response to an injury or illness. Marlow also learns that the Smart Car Guest User application allows her to access to some of the functions of the First Cosmic Smart Car app, such as the ability to call the vehicle from its parked or auto-cruising location to drive to where she is on the street to be picked up, or to turn on while in a parking lot to heat or cool the car before she gets in, or to pick up ordered from a restaurant and deliver it to Marlow. Marlow, upon arriving in town, requests the vehicle to meet her at the airport, where it correctly identifies her on the curb amid many other people. Recognizing that Marlow has a large suitcase, the vehicle greets Marlow, confirms her identity, and asks her to take her bag to the rear, where a robotic baggage trolley gently pulls her large bag into the trunk and, after verbally confirming that there is nothing else to load in the trunk, closes the trunk and invites Marlow to get into the rear passenger seat as the nearest door opens. Once Marlow is inside, the vehicle asks Marlow if she would like to practice her covert security rules, and if so, then runs her through several drills to confirm that her selected gestures are properly recognized and that Marlow remembers the meaning of the commands and the situations in which they should be used. A video display summarizes her rules for reference as she drives, and a text message or other written or graphic communication is sent so summarize them also. Marlow is now one of several other users that Sandra has authorized for use of her vehicle. Sandra can use her First Cosmic Smart Car app to review the usage and driving history of each of these drivers and see notifications for any possible rule violations or unusual issues or expenses, and can verify that driving was done by the authorized person.

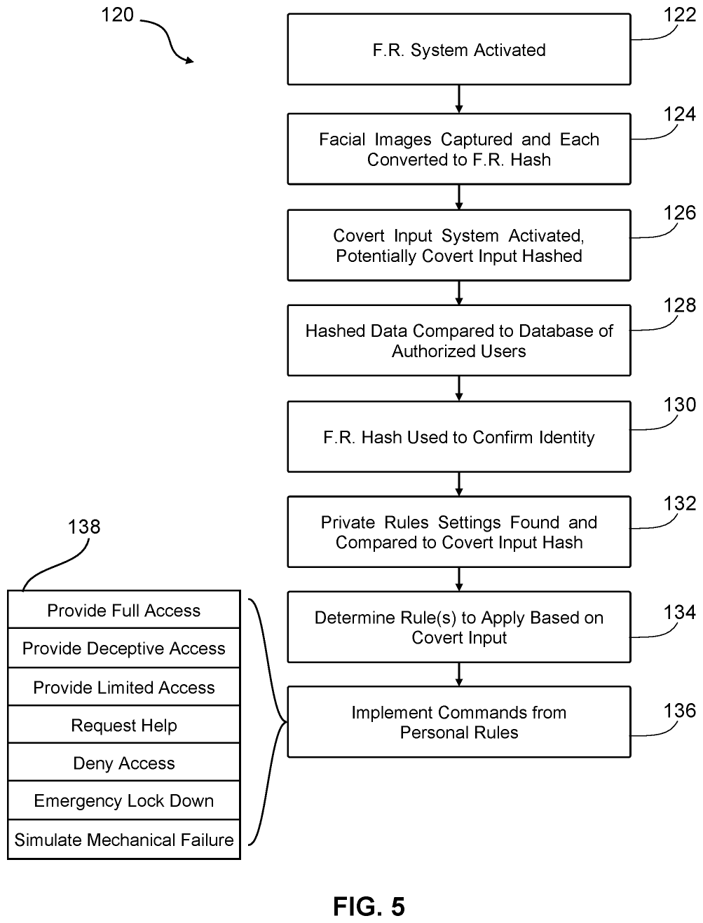

FIG. 5 depicts a facial recognition-based security method 120 that begins when a user (not shown) activates a facial recognition system 122 by approaching a facial recognition input device, being prompted for facial recognition-based authentication by a cell phone or other device, etc. Facial images are then captured and converted to a F.R. hash 124 that provides key data extracted from the images which can then be efficiently compared to a stored data. Simultaneously, shortly afterwards, or even shortly before the capture of facial images 124, a covert input system is activated 126 which acquires additional input from the user to convey covert cues to be interpreted according to the user's predetermined Private Rules configuration stored in memory such as in a Private Rules database (not shown). The additional input can be optionally hashed, as may be useful if the covert input involves a visual cue from the user such as a facial gesture or action acquired by a facial recognition system or other image acquiring system. The hashed data obtained from one or more facial images is then compared to database information for authorized users 128, and the hashed data from an authorized user is used to confirm the user's identity 130. Once the user's identity is established, existing Private Rules settings pertaining to that user are obtained from a Private Rules database in step 132 and compared to the covert input, which may also be hashed. Based on the results of that comparison, the intended rules can be determined in step 134, based on the covert input as interpreted according to the user's Private Rules, and these rules are then executed in step 136. The rules implemented may be selected from a list of options 138 such as providing full access, deceptive access, or limited access, or issuing a request for help, denying access, instituting an emergency lock down, and simulating mechanical failure, etc.

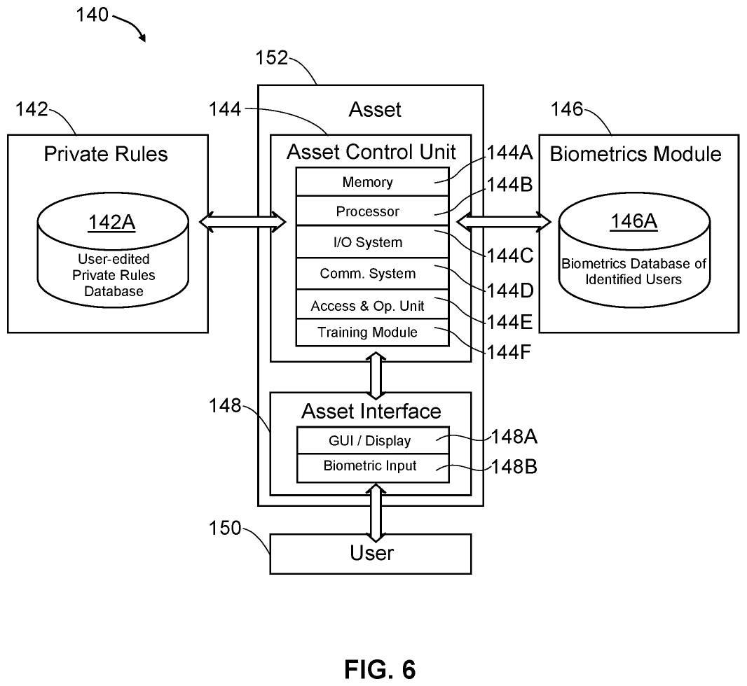

FIG. 6 shows an asset protection system 140 for protecting an asset 152 which may be a vehicle, an electronic account, a safe, a secured building or room, and so forth. The system 140 comprises a Private Rules module 142 comprising a user-edited Private Rules database 142A and a biometrics module 146 comprising a biometrics database 146A of identified users. Either or both modules 142, 146 may be physically integrated with or attached to the asset 152 or may be remotely located. Identified users may have differing levels of possible access such as full access (provided criteria in the Private Rules module 142 are met), limited access (e.g., for a vehicle, a limitation in terms of distance or duration of use, or for a financial account, limitations in amount that may be spent or how the account may be used), or denied access for someone known to be a threat or who has failed previously to comply with conditions of use, etc. Access is regulated by an asset control unit 144 which comprises a memory 144A; a processor 144B; an I/O system 144C for receiving and providing data from an asset interface 148; a communications system 144D for sharing and receiving information with one or more remote sources such as a police station, a security office, an emergency dispatcher, etc., as well as off-asset databases or modules which may include the Private Rules module 142 and the biometrics module 146, or at least the databases 142A, 146A thereof; an access and operations unit 144E which controls the physical or electronic barriers to access for a user (e.g., opening a door, allowing log in, turning on a power source for use of the asset, etc.) and which may control the operation of the asset 152 by the user, as in regulating how the asset 152 may be used or how it performs (e.g., controlling the speed or operation of a physical or the features or behavior of an electronic access); and a training module 144F which can periodically require testing and training.

The user 150 interacts with an asset interface 148 that may comprise a graphical user interface or other display 148A and a biometric input system 148B which comprises at least one biometrics device such as a camera, a microphone, an iris scanner, a fingerprint reader, a gate detector, and the like. The biometric input system 148B may be integral with, connected to, or not connected to the graphical user interface or other display 148A. The latter may comprise a graphical interface on a cell phone, an illuminated screen or display on a vehicle window or display screen, and so forth (not shown). The asset control unit 144 further comprises an access and operations unit 144E that may be adapted to control physical or electronic access to the asset 152 and its performance or behavior. Thus, when the asset 152 comprises one or more vehicles (including a fleet of vehicles), the access and operations unit 144E may govern the user's access to one or more of the vehicles, including controlling locks and ignition, as well as controlling performance of the vehicle such as speed, distance traveled, engine operation (e.g., simulated failure under some conditions), especially in cases where access, according to constraints imposed in accordance with the Private Rules module 142, is limited or deceptive. Other constraints can be considered for other situations, such as when the asset 152 is a financial account or a secure building or room.

The training module 144F assists the user 150 in understanding the use of the Private Rules module 142, or rather the ways to properly convey the user's desire to implement the various options provided for in user-edited settings recorded in the Private Rules database 142. Such options may include covert cues entered via the biometrics input system 148B or via another sensor or input system (not shown) giving a signal that can be provided at a time close to the time of providing biometrics input through one of the at least one biometrics devices associated with the biometric input module 148B. The biometrics data and data from any other sensors or input devices is then provided to the asset control unit 144 for evaluation in light of the relevant retrieved data from the biometrics database 146A and for identification of the user 150. Evaluation also includes determining if the identified user 150 has established commands in the Private Rules database 142A that require detection of covert cues to control access to the asset 152 or to provide additional instructions such as communicating with police or others. The training provided by the training module 144F may be periodic, based on a predetermined schedule, and/or based on the determination by programming in or associated with the asset control unit 144 or by third-party observers (e.g., outside authorities or the service provider for the asset protection system 140) that the user may have been confused or ineffective in using the Private Rules module and thus would benefit from further training, including practice for the various scenarios related to the rules selections in the user-edited Private Rules database 142A.

The asset interface 148 is operatively associated with the asset control unit 144 and may be physically integrated or adjacent, physically separate, and either or both may be physically attached to the asset 152 or a part thereof. Multiple asset interfaces 148 may be available and multiple users 150 may be able to interact with the asset interface simultaneously, as when the asset 152 comprises a fleet of vehicles capable of use by multiple users simultaneously.

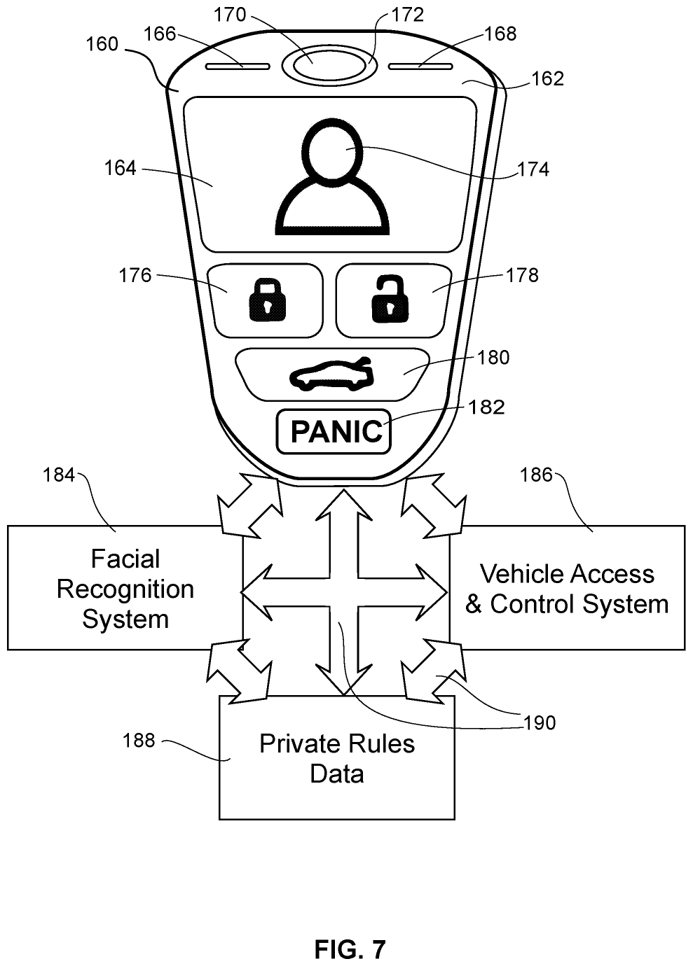

FIG. 7 depicts a fob 160 or other electronic device that can convey biometric information to a security system for protecting an asset (not shown) with options for customization and use of covert cues according to a Private Rules feature. The asset envisioned in FIG. 7 is an automobile, though it may be an airplane, boat, storage unit, vault, safe, secured room or building, computer, electronic account such as a bank or brokerage account, health care account, etc. The fob 160 has a body 162 comprising a display screen 164 which is operatively associated with a camera 170 for capturing and displaying an image 174 of a user from a photograph taken by the camera 170 with the optional assistance of a light source 172. The fob 160 may also comprise a microphone 166 for receiving sound input from the user and a speaker 168 for playing audio messages or prompts to the user. Other buttons suitable or commonly employed for the specific purposes of the fob 160 may be present, and by way of example in the case of an automotive fob 160, could include a lock button 176 for wirelessly communicating with an automobile to lock it, an unlock button 178 for remote unlocking of the automobile, a trunk release button 180 for opening a trunk, a panic button for conveying an emergency situation 182 which may result in alarms being sounded or communicated to others, etc.

The fob 160 is operatively associated with an F.R. system 184, a vehicle (or asset) access and control system 186 that can regulate access to and performance of the vehicle of other asset, and Private Rules data 188 in which a user's Private Rules specifies how the vehicle access and control system 186 will respond in light of covert cues that maybe provided through the facial recognition process (e.g. facial gestures or other motions visible by the camera or other signals conveyed through the fob 160 such as a voice command detected via the microphone 166 or a physical motion with the fob 160 such as shaking it or revolving it in a predetermined way (in that case, the fob 160 may also comprise accelerometers to detect physical motions). Thus one or more covert cues may be specified in the Private Rules data 188 that may be require for full access or may allow private signaling about the performance or hidden barriers to use of the asset. The exchange of data 190 between the systems 184, 186 and Private Rules data 188 analyzed with a processor (not shown) that may be embedded in the fob 160 or in whole or in part located remotely on a processor.

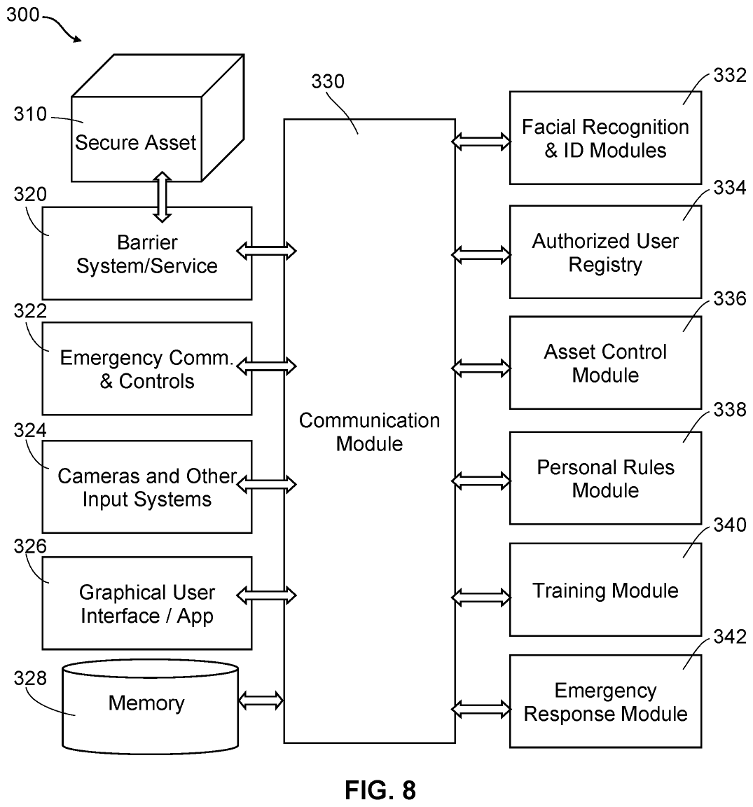

FIG. 8 is a schematic of the various modules and hardware systems of a security system 300 in which facial recognition and other ID modules 332 system and a personal rules module 338 cooperate to enhance the security of a secured asset 310, in particular showing interactions of various components with or via a communications module 330. Modules shown to the right of the communication module 330 include a facial recognition and other ID modules 332 (the other ID modules can include voice recognition, gait recognition, iris recognition, finger print recognition, and any other biometric ID system or other ID system, including scanning a passport or driver's license, reading an RFID chip, receiving an authentication signal from a cell phone or other wireless or Internet system, etc.). Also included is an authorized user registry 334 containing information in non-transitory computer-readable media regarding authorized users, their identifying features or credentials, the assets they are authorized to use, etc. Further, an asset control module comprises systems for controlling, such as instructions on non-transitory computer-readable media, for controlling the barrier system or barrier (protective) service 320 that physically and/or electronically protects the secure asset 310, and is adapted to provide instructions to give different levels of access including options for deceptive access, limited access, denied access, etc., as described herein. A personal rules module 338 contains information regarding previously established personal rules for one or more authorized user, and may provide such rules for all users as desired. A training module 340 is adapted to periodically assist an authorized user with personal rules to practice use of the rules according to various scenarios in which the rules may be needed. An emergency response module 342 provides directions for responses in case a covert signal is provided by an authorized user via the facial recognition and other ID modules designating a status of duress, danger, or emergency, requiring an emergency response to protect the user and/or protect the asset.

These modules interface with the communication module 330 and thereby interact with the appropriate tools, systems, or hardware shown in the left of the communication module 330 such as the emergency communication and control system 322, which may include means for sending signals to authorities, police, security guard, administrators, family members, etc., and may include means for activating defensive or offensive equipment such as an airbag in a vehicle to stun an aggressor, or may take actions to interfere with a crime or duress situation using a variety of means such as control of a sprinkler system or pressurized source of water or air, alarms, lights, barriers, robots, mechanical arms, electric arcs, smoke, fire, frightening sounds, sonic or ultrasonic devices that can cause pain or distress, release of guard dogs, etc. Also shown are cameras and other input system 324 which can include various biometric measurement tools, microphones, etc., strain gauges for detecting the position and motion of individuals across a floor, etc.

Also shown is a graphical user interface 326 which can be used to activate various portions of the system or to configure the system including setting up or modifying personal rules. A memory 328 is also shown, which is generally a non-transitory computer-readable medium that may contain various databases and instructions, and may be divided between a plurality of hardware devices adapted to cooperate with various modules, tools, and systems of the security system 300, or may be integrated onto a single device (not shown).

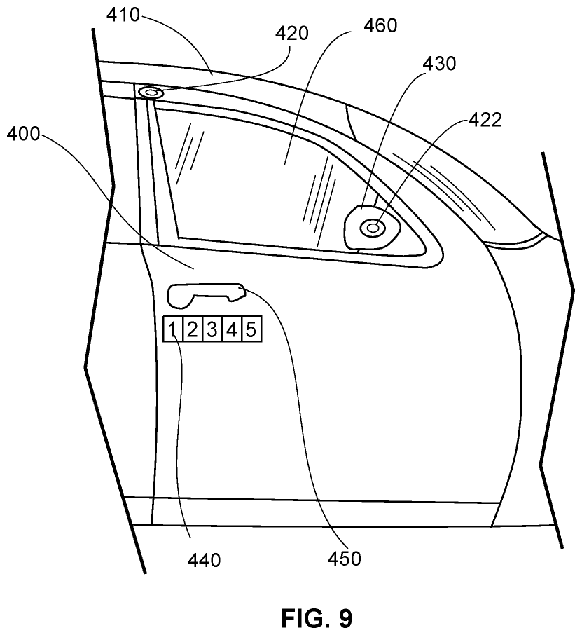

FIG. 9 shows an automobile door 400 of an automobile 410 adapted to cooperate, in protecting access to the interior of the vehicle, with both a facial recognition system comprising one or more cameras 420, 422 associated with the automobile 410 and also comprising a physical credentials entry device 440. Here two cameras are shown, one door camera 420 mounted at the top of the door 400, a side-mirror camera 422 mounted on the side mirror 430, although any number of configurations may be suitable.

The credentials entry device 440 here is depicted as a physical PIN pad having buttons for the digits 1 through 5 for entry of a PIN, although many other credential receiving systems could be used such as a password entry system such as an alphanumeric keypad or a virtual keypad displayed in a graphic user interface projected onto a window; a password entered into a cell phone or other credentials associated with a cell phone; a swipe entry system for reading a magnetized car or other systems for reading physical objects such as fobs comprising chips or RFID tags; a biometric system such as a finger print reader, palm scanner, iris reader, voice recognition device; or other credentials entering system could be used such as an, a fingerprint reader, voice recognition module, etc. When a user approaching the automobile 410 is properly identified by the facial recognition system associated with the cameras 420, 422 and by entry of other credentials such as entry on the PIN pad 440 of a recognized PIN, the user may gain access to the interior of the vehicle by using the door handle 450 to open the door 400, or the door may open automatically without the need for a handle 450. However, in being monitored in proximity to the car by the facial recognition system associated with the cameras 420, 422, the user may have made various security related entries covertly through the use of gestures or a predetermined code on the PIN pad, or through other covert means with the PIN pad as described in U.S. Pat. Nos. 7,552,467 and 9,959,694, incorporated by reference in their entireties. Thus, predetermined security rules (Private Rules) may be implemented based on covert actions taken to control access to the automobile 410.

The selection of one or more specific personal security rules may then govern the response of the vehicle to the occupants of the car or to the act of driving the car, either by a driver or by an autonomous driving system, or may affect the ability of the car to operate at all. Thus, access may be denied, limited, feigned, or provided with various emergency and rescue protocols according to the secret personal rules that have been covertly invoked through the process of user authentication. User training to understand and practice the rules may also be implement by the security system protects the automobile 410.

A graphic user interface (not shown) displayed on the window 460, if used in place of the PIN pad depicted for the credentials entry device 430, could use a video projection tool, a grid of LED lights, an electronic flexible display mounted on the window, an electric ink display, a plasma screen, or any other system adapted to display a graphical image on an automobile window 460 in either daylight or in the dark, wherein a user can make selection or perform motions relative to the window 460, in contact or near contact therewith, to make selections that can select a password or meet other identifying criteria such as selecting predetermined portions of an image according to a secret rule such that the interactions with the GUI are interpreted as a password or credentials, rather, that help authenticate a user. Such credentials, whether a password, PIN, or other entry, can also be responsive to personal rules in a Private Rules database (not shown) that can then provide additional input to direct specific security states, security measures, emergency measures, levels of access, etc.

The cameras 420, 422, like any of the cameras mentioned herein,may be on rotatable mounts that can swivel in various directions or along up and down or side to side axes, as desired, or they may be fixed mounts that do not provide for swivel. The cameras may include zoom functionality, such as from lx to 10x zoom, and may operate in visible light, infrared, and UV as desired. In some embodiments, cameras may be or have the option to be insensitive to IR or other frequency ranges (e.g., UV) to reduce the impact of methods that seek to thwart facial recognition cameras using strong light outside the visible spectrum such as glasses or accessories that emit strong IR light to “blind” the camera to facial features.

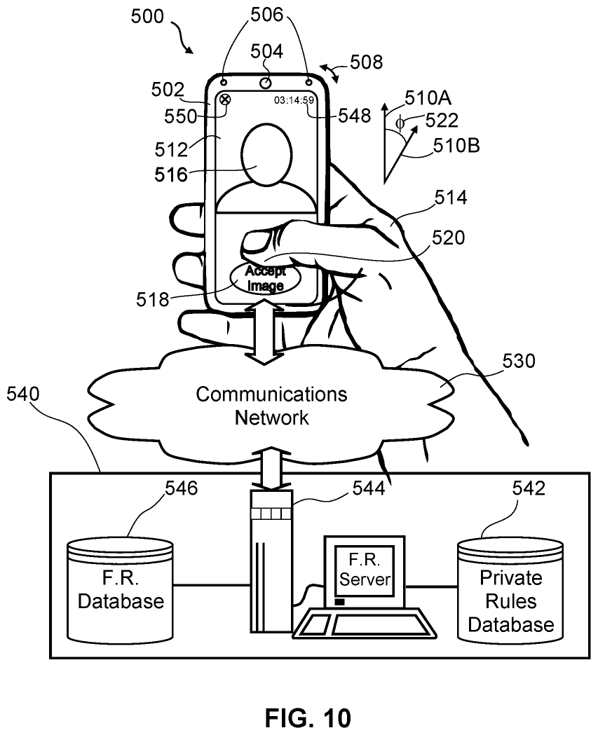

FIG. 10 depicts an F.R.-enabled security system 500 involving a cell phone 502 having a display screen 512. The system can be used for accessing an asset (not shown) through facial recognition via the phone 502, or alternatively can be used to unlock a phone and access various apps and data on the phone or accessible via the phone 502. The phone 502 comprises a camera 504 that can take an image 516 of the user. Lights 506 may be used when needed. The user's hand 514 holds the locked phone 502 and seeks to unlock it or to otherwise be authenticated as an authorized user through a facial-recognition system for authentication. The F.R. software and F.R. data may be embedded in memory (not shown) on the phone 502, or may in part or in whole be provided by one or more remote servers and databases 540, as depicted here, via a communications network 530 that reaches, in one embodiment, an F.R. server 544 in communication with a F.R. database 546 and a Private Rules database 542, which may specify the results of machine-recognizable covert actions such as a shaking 508 of the phone or holding the phone such that the orientation of the phone 5106 relative to the vertical axis 510A makes a specific angle ϕ 522, such as from 40 to 50 degrees. Covert actions may also be made through the use of facial actions such as pursing or licking the lips, winking an eye, touching an ear, tilting the head, wrinkling the nose, and so forth, either in a particular sequence, at a particular time, etc. For time-based covert actions, the current time 548 may be displayed on the screen 512, here opposite the “close/cancel” button 550. When an acquired image is deemed acceptable for facial recognition processing, the user can press the “accept image” button 518, although the system may acquire suitable images automatically without a need to actively send an image to the F.R. system for authentication. The act of pressing the “accept image” button 518 can also be a source for covert actions such as pressing the border of the button and then sliding the finger tip in a certain pattern, e.g., a circle or “Z” shape, before releasing pressure, or pressing the button in a particular spot such as on the letter “I” of “image,” etc. The absence of such a covert action, as defined in the user-edited Private Rules database 542, may result in limited, deceptive, or denied access.

The F.R. system requires a view of the user's face obtain a corresponding image 516 to unlock the phone 502 or authorize access to the asset via the phone 502. In one scenario related to unlocking phones, if the phone 502 has not been accessed for a lengthy period of time and is in an unexpected location away from the user's home, work place, or other typical locations for the user, the F.R. system can be programmed to require a more complete authentication versus merely awaking the phone a few minutes after routine use at home or work. The more compete authentication takes place according to the rules given in Private Rules database 542 and may comprise a signal to the user indicating that a Private Rules-enabled login is required. That signal may be a flashing light, a vibration of the phone, a sound such as a bird chirp, or a line of text such as “Authenticating . . . ” or “Please login.” In this case, the user may be required, for example, to hold the phone 502 at a specific angle 522 before looking at the camera and smiling, followed by a quick shake 508 of the phone after the “success” indicator is displayed. In this embodiment, the login appears to be successful before a covert cue has been fully entered, but the access provided will not be full access until that cue has been completed. Were the final shaking missing, access may be deceptive, limited, or denied, as specified in the Private Rules database 542.

In one embodiment, an F.R. system comprising Private Rules is used to configure and subsequently to authenticate a user's access to a SIM card, optionally including a virtual SIM card service or system that can provide access to various international phone systems without the need to pay roaming fees, such as the virtual SIM technology described in U.S. Pat. No. 9,736,689, “System and method for mobile telephone roaming,” issued Aug. 15, 2017 to J. Liu et al. The '689 patent describes an authentication bank comprising a plurality of physical identification modules that comprise one or more memory, processors, programs, and computer readable media storing subscriber identity module (SIM) and authentication information. As adapted herein, the authentication information can include F.R. information and information pertaining to the user's Private Rules for governing an authentication process that comprises a F.R. step and that can include covert information conveyed via the F.R. system or through other means. Information pertaining to the user's Private Rules may comprise a pointer such as a hyperlink or database address where a Private Rules database is maintained, or may comprise data stored in the memory of the phone without the need for wireless transfer of data to access the Private Rules information. that can be accessed without the need for transmission of The Private Rules data. In the virtual SIM card system, at least one of the one or more programs stored in the memory comprises instructions executable by at least one of the one or more processors for: receiving a first request for authentication information, wherein the first request was transmitted over a data channel, for associating a subscriber identity module (SIM) with a foreign wireless communication client or an extension unit, wherein the SIM is subscribed to a local carrier for a current location of the foreign wireless communication client or the extension unit, wherein the foreign wireless communication client or the extension unit is a wireless device not subscribed to the local carrier, and wherein the first request for authentication information comprises information regarding a second request for local authentication information received by the foreign wireless communication client or the extension unit from the local carrier over a local cellular communication network; retrieving subscriber identity information and authentication information for the foreign wireless communication client or the extension unit from the SIM; sending the subscriber identity information and the authentication information to the foreign wireless communication client or the extension unit over the data channel, wherein the data channel is distinct from local wireless services of the local carrier and wherein the authentication information for the foreign wireless communication client or the extension unit retrieved from the SIM is configured to be sent by the foreign wireless communication client or the extension unit to the local carrier over signal link of the local cellular communication network to provision a communication function from the local carrier for the foreign wireless communication client or the extension unit.

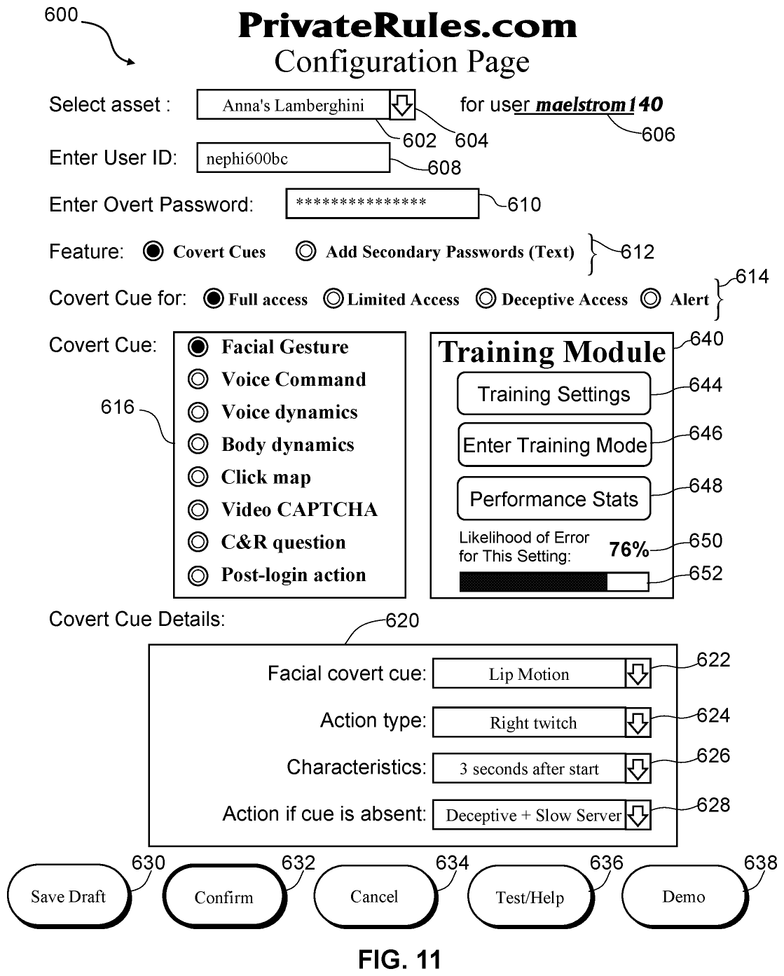

FIG. 11 depicts one portion of an administrative interface showing a configuration page 600 for a security management system for defining security rules for a secure electronic account. Though innumerable interface designs could be considered, the depicted embodiment shows a configuration page 600 of a Web-based administrative interface accessed through a Website, PrivateRules.com. The portion of the administrative interface shown contains an account selection tool 602, shown here as a dropdown box with a variety of predetermined accounts or assets to select (here shown as a vehicle, Anna's Lamborghini), wherein a button 604 on the account selection tool 602 provides access to alternate choices. The configuration page 600 may provide control over an arbitrarily large number of accounts belonging to or accessible by the user, or may be for a single account. A PrivateRules.com user ID field 606 shows the user ID used to login to the administrative service, here depicted as maelstrom140. For the selected account, there is an account-specific user ID shown in the user ID field 608. This field may be automatically populated from stored information when the account is selected by the account selection tool 102, or may be entered by the user to provide or update that information. For the particular user ID for the selected account, there is an overt password that is entered into the overt password field 610. The overt password represents the text string that the selected account or asset requires to be entered for access by the user using the designated user ID. In some cases, instead of an alphanumeric password, the credentials required may be a facial image of the user that can be verified by an F.R. system, or may comprise other biometric inputs, use of a security fob or cell phone app or other credential input tools, which selection options that will vary depending on the account or asset that has been selected in the account selection tool 602. Using the configuration page 600, the overt password may be coupled with covert components to define primary or secondary passwords, in effect, or may be one of several passwords each assigned various access levels. Display of the actual characters of the overt password may be suppressed, as shown, or, if desired, the overt password can be displayed or provided by email or other means if forgotten. For security purposes, overt display of the password in the overt password field 610 may be undesirable.

Beneath the overt password field 610 is a feature selection area 612 in which the user can select security features to add to the security system associated with the selected account. Though many such features are possible, two are shown are provided with radio buttons for selection, namely, a “covert cues” feature and an “add secondary passwords” feature. The “covert cues” button has been selected in the features selection area.

In response to selecting “covert cues”, additional content is displayed on the configuration page 600 of the user interface, providing a covert cue specification area 614 with various radio buttons to specify what the covert cue will signify when coupled with the primary password. These significations include “full access” (meaning that use of the specified covert cue coupled with the overt password will constitute a primary password providing full access or a relatively high level of access to the asset), “limited access”, “feigned access”, and “alert” (indicating that a security alert should be issued should the covert cue be received). Here, “full access” has been selected in the covert cue specification area 614.

Also shown is a covert cue method selection box 616, allowing the user to select from a variety of covert cue methods. The methods depicted include facial gesture, meaning a covert cue made by a facial expression or motion; voice dynamics, meaning a vocal covert clue such as a particular word or noise (e.g., a cough or sigh made after stating the user's name), or a particular way of saying a phrase that may involve tones, pauses between words, inflections, deliberate errors in pronunciation, emphasis on particular syllables, etc.); body dynamics which can involve motions or positions of parts of the body such as feet or hands at a particular time; controlled error (meaning a deliberate error and correction scheme such as as described in U.S. Pat. No. 7,552,467); video CAPTCHA (described above); a challenge and response (C&R) question (described hereafter); and a post-login action (referring to actions taken by the user immediately or shortly after logging in or gaining provisional access to the asset to confirm identity and ensure full access). Naturally, many other options could be considered. The list shown is for illustrative purposes only.

Challenge and response (C&R) questions, like the video CAPTCHA system, provide users with a question having known answers that can help further verify the identity of a user. The questions may be predetermined with user input or may be automatically generated based on known information about the user. Covert cues can be provided by making predetermined deliberate errors (e.g., misspelling a relative's name, entering an incorrect date, adding an extraneous character in a typed response, etc.) or by complying with other predetermined covert criteria such as the place where a user clicks on an “enter” button or the value of the seconds shown on an on-screen clock when the user enters the C&R answer.

The selected item shown in the covert cue method box 616 is the “Facial Gesture” radio button. In response, the “covert cue details” region 620 is populated with relevant information specific to facial gesture options for covert clues, such as a drop-down box to select the facial covert clue type 622, here showing “lip motion” as the selected option, indicating that in displaying the face for authentication to gain full access to the asset, the user should also make a specific facial gesture with the lips. The “action type” field 624 allows the user to specify the specific lip action to make, here shown as “right twitch,” meaning to twitch the right side of the lips rightward. While a wide variety of predefined actions may populate the “action type” field 624, it may also have a “customize action” selection (not shown) in which the user can name and demonstrate a specific new action of the lips or whatever facial covert cue or other covert cue has been selected, which may then invoke a machine training feature to train the F.R. system to recognize the characteristics of the specific motion being made. The machine learning process may require multiple executions of the intended new action type under various conditions which the system may simulate and/or enact via directions to the user, such as obtaining images under various types of lighting, at various distances from the camera, at various head angles, with different backgrounds, with different degrees of motion (e.g., a small motion versus an exaggerated motion), thereby allowing a neural network (not shown) or other machine learning system to learn to recognize the action well and create the definitions of the customized motion to be stored in memory for future use so that the named new customized action can then be listed as an option under the appropriate menu such as under the “action type” field 624 or the “facial covert cue” field 622.

The “characteristics” field 626 specifies further information about the facial covert cue such as its physical magnitude, temporal duration, symmetry, timing relative to any other actions or relative to signals given to the user from the F.R. system, etc. Here a temporal characteristic of “3 seconds after start” is shown, indicating that the user should wait to make the lip motion until 3 seconds after the facial recognition image is acquired (perhaps manifest by a flash or by an “image acquired” alert on the F.R. interface). The “action if cue is absent” field 628 shows what action or actions are to be executed by the system if the specified covert cue is absent. Here the user has selected “feigned+slow server”, meaning that feigned access to the asset is provided in combination with an apparent slow down to hinder activity by a potentially unauthorized user, without making it easy for an unauthorized user to realize that full access has not been granted.

Additional buttons below the covert cue details region 620 include a button to save a draft form of the settings 630 (requiring further confirmation with the confirm button 632 to be made live), to cancel changes 634, and to conduct testing and obtain help via the “test/help” button 636. Help may include training of the user and optionally training of the system where needed to better recognize covert cues. The help feature may also provide access to verbal or written instructions, manuals, online training, live chat help, or other resources to assist a user in implementing a customized security system employing Private Rules and covert cues. The “test” feature of the “test/help” button 636 can cause trials to be conducted to debug settings or evaluate the level of security provided.

The “demo” button 638 can cause the system to provide a video demo 638 showing the user what the selected covert cues should look like. The demo feature 638 may include recorded video or computer-generated/augmented video showing one or more hypothetical scenarios in which a user takes advantage of the Private Rules system with the specific settings currently under consideration to protect the asset. Thus, the user may see how the selected security rules should be implemented and determine if the settings are suitable for the user.

The “confirm” button 632 overwrites previous settings for the selected account with the criteria entered on the configuration page, making the new settings go live relative for the selected asset.

In some embodiments of the systems disclosed herein, recognition of specific high-risk or blacklisted individuals may be used to trigger preemptive or precautionary measures such as signaling authorities that a potential high-risk individual is near the asset or attempting to access it, or an alert may be sent to the asset owner or administrator regarding the incident, and suitable defensive measures may be taken to protect the asset, notify authorities, warn the person to depart, alert employees, forbid access to other assets or locations, sound an alarm, etc.

In transportation-related embodiments, cameras inside a vehicle may be used to monitor people or animals outside the car as well as people or animals inside the car, and/or one or more external cameras may be used, such as a camera with 360-degree access on the roof of the car or cameras mounted in or near the frame of each door or cameras mounted on both sides of the car. Each camera is associated with a computing device that can process facial images and compare the images to a database of facial information to identify a potential match with an authorized user and optionally with a blacklisted threat known to be a concern to the user or owner of the vehicle, with optional rules established to specify actions to take should such a person approach the vehicle or particularly should such a person seek to or actually gain access to the interior of the car. Comparisons may also be made with other databases for large numbers of individuals.

Humans are not the only threats that need to be considered nor, nor the only authorized users of some assets. Animals such as dogs or other mammals may be threats or trusted users authorized to access some assets such as a home, office, kitchen, elevator, etc., and may be identified through facial recognition or other graphic recognition systems, in addition to being recognized based on tags (e.g., tags equipped with chips having unique ID signals), accompanying human, paw prints, odor, DNA sample, and other features. Certain pets may also be trained to provide authenticating gestures or expressions to select various responses or levels of access. Further, some animals may be identified as threats to be barred access to an asset or to invoke a security alarm or elevated security threat status by their presence near a protected asset. Such features can be programmed into the security system to add layers of protection involving not only humans, but also animals.

### EXAMPLES

Example 1. In this prophetic example, an automobile is adapted to provide a deceptive access mode and/or limited access mode in which it appears to be out of fuel or lower in fuel than in reality. The user, through a facial recognition system, provides a covert cue via an expression, series of expressions, a gesture or series or gestures, or combination of verbal and visual cues, etc., that requests deceptive access or limited access involving feigned low gasoline. Depending on the selections made in the personal rules for the user, this may result in the vehicle's control system informing the occupants that the vehicle is nearly out of gas and must go directly to a gas station to refuel. Alternatively, it may result in the vehicle simulating an out of gas condition in which the car stops running and must pull off to the side of the road to receive assistance. Alternatively, the low gas condition may be used to enforce a limited access rule that limits the distance a driver may drive the vehicle. Such embodiments generally involve the security system for the vehicle being in electronic and/or mechanical communication with the gas gauge, with the fuel pump or fuel delivery system that provides the engine with fuel, and optionally with the control panel for the vehicle to provide alerts or warnings about the low gas condition. Alternatively, a mechanical or electrical failure may be simulated to provide limited or deceptive access (deceptive access occurring when the user, after entering the vehicle and thinking access has been gained, finds the vehicle cannot be operated due to a feigned malfunction).

In some embodiments related to low gas conditions, an autonomous vehicle may pretend to be driving to a gas station but in reality will proceed to a place deemed to be safe such as a police station. In other embodiments it may go to an actual gas station but a signal may have been sent to the police and/or other cooperating agents, possibly including those at the gas station, requesting assistance in a duress (e.g., hostage) situation. The stop at the gas station is thus intended to provide a chance for the user to escape or receive assistance. Further measures may be taken to limit the actions of the assailant.

Such embodiments can be adapted to other vehicles and other devices or settings. For example, the out of gas scenario can be used to meet the security needs of a user of a boat, a motorcycle, an airplane, a truck, a bus, a hovercraft, a submarine, a tank, etc. Electric vehicles can also be considered, wherein the battery charge would be the metric that is used instead of fuel level.

Example 2: Elevator Access. In a building where the executive floor is provided with added security, users of the elevator system normally cannot access the executive floor unless the elevator security system recognizes them as authorized. Turnstiles limit access to the elevator lobby except for those who are authorized by security cards that can be read electronically and a facial recognition system. When a user swipes a card to enter the elevator lobby, they are automatically directed to the elevator shaft that will be assigned to take them to their default floor. But the user may be authorized to access a variety of floors, and can make a non-standard selection at a security screen in the elevator lobby. Upon swiping a card, a facial recognition system confirms the identity of the person and provides a list of floors to select, and selection is made on a touch screen or by verbal command. If the user is authorized to access the executive floor, using a card is not enough to gain access, but facial recognition is also required. However, personal rules may be available to limit or feign access in response to a particular facial expression. Under limited access, a facial expression may eliminate the executive floor from the list of accessible floors. Under deceptive (feigned) access, an executive floor may be listed but in reality the elevator will go to a different floor. Emergency alert conditions may also be signaled that will result in security personnel assisting the user in the lobby. Feigned elevator failure can also be initiated, such as a feigned mechanical failure that prevents the doors from closing and requiring security personnel to come investigate.

The interior of the elevator may also have a facial recognition system in which a user apparently authorized to travel to the executive floor must first be screened and shown as authorized before the elevator will travel there. In one condition, the elevator will only access the secure floor if all users remaining in the elevator are authorized users. If an unauthorized companion is present, unless a predetermined covert facial expression is provided to allow companions to access the floor, then the elevator may respond in different ways such as going to a different floor where security personnel can investigate and ensure that unregistered personnel leave before the elevator continues to the secure executive floor.

Example 3: An asset is made available for rent to an authorized user and is protected with a security system comprising a facial recognition system in communication with a non-transitory computer-readable medium comprising directions for a private rules system based on previous selections from the owner and/or authorized user. Selections made by an owner may be communicated to a user who may agree with the rules or request changes to be made or directly edit the changes through a rules selection interface, which may be provided on a phone application associated with the rental of the asset. Access to the asset under a rental contract, which may be a smart contract on a blockchain, can be provided according to personal rules that give the authorized user access via a facial recognition system, along with various levels of access or options to signal duress or emergency with covert cues provided through the facial recognition system and/or other input systems. Thus, in one scenario, a user signs up via a web site to rent a car that is available for access at an arbitrary location in the city. A web app allows the user to provide facial recognition data that can be recognized by a facial recognition system associated with the car and/or the facility where the car is available. In one scenario, the user has selected certain facial expressions to be associated with certain security states, and requires a series of expressions to gain full access to the car. Upon approaching the car, the user makes the predetermined series of facial gestures and gains full access to the car, and is able to drive it away. Similar systems can apply to a wide variety of renting or contractual situations such as gaining access to a rented home or apartment via AirBNB, accessing a hotel room, renting a boat or vehicle. Thus, in some embodiments, a renter can pre-register or register upon arrival at the asset or a rental facility in order to access the assess using facial recognition, wherein a specific action, including a covert or relatively covert action may be defined for use in addition to conventional facial recognition alone to authorize the user for the intended level of access to the asset. Optionally, the user may also select specific actions to add security features for various scenarios in order to provide other levels of access such as feigned, deceptive, denied, and/or alarmed access through the use of a specific action or the absence of the specific action required for full access. The registration process may take place on a renter's interface similar to that of FIG. 11, adapted to allow the renter to customize personal rules as desired within constraints defined by the owner or administrator. The renter's personal rules choices are then communicates to the asset control system. Optionally, a testing and training system may be used to allow the user to test the Personal Rules system and ensure that the user is capable of achieving full access and to also practice executing different levels of access based on various scenarios of concern to the renter. The training system may identify weakness in the renter's performance and either provide guidance for improvement or recommendations for modifying the settings to ensure that actions are selected that are more successfully executed and recognized by the security system.

In one embodiment, the method of renting an asset includes the following steps: 1) registering via a smart phone, kiosk, or computer, 2) providing facial recognition data, 3) selecting personal rules in response to various expressions or gestures, if desired, 4) approaching the asset, 5) being recognized and granted access by the security system associated with the asset, 6) if personal rules have been selected, being prompted by a training module for the security system to test and practice the use of the personal rules to invoke desired security features in response to various scenarios, 7) being prompted to make or accept changes to the settings to better meet the needs and abilities of the user based on evaluation of the user's performance during the testing and practice of step 6, and 8) continuing to use the asset. Personal rules may govern responses for normal access, duress or criminal activity (e.g., providing feigned or limited access and/or taking other emergency or rescue measures), emergency medical or other emergency conditions, and conditions where various forms of limited access may be desired.

Smart contracts may be used for the rental, with related information added to a blockchain. A public key may be given to individuals who the user may wish to also be able to drive the car, and they may also be allowed to add their own private rules in response to their facial recognition actions. Examples of smart contracts for automobile rentals include the HireGo system for rental cars (https://www.hirego.io/), built on the Ethereum blockchain platform. Examples of smart contracts using blockchain for apartments or property rentals include Midasium's smart tenancy systems (Midsium, London, UK).

Example 4: A Bitcoin or other crypto currency wallet is protected with a security system involving facial recognition and a cell phone. Access to the wallet and actions to spend or transfer the cryptocurrency can be controlled with personal rules to require more than mere authentication as a living authorized user, but can also require certain expressions or gestures to authorize the transaction. Failure to include the covert action can result in a feigned transaction or denied access. Alternatively, the system can be adapted to add substantial delays to a transaction with options to kill the transaction while pending (e.g., a two-hour delay can be set). A delayed transaction can also be set to require a second form of verification such as responding to an email or text message to be sent after a certain time to authorize the transaction. These existence of these delays or additional requirements may not be visible or obvious to a thief or onlookers. The response to an attempted transaction made under a security setting invoked by certain facial features or other covert cues can also result in security measures such as temporally locking the account and contacting security personnel or administrators regarding an apparent duress situation or criminal transactions. Such measures can also be incorporated into the conditions and rules governing a smart contract to ensure that payments made or other transactions take place with proper authorization and not due to fraud.

Example 5. For a cell phone that is protected with facial recognition and Private Rules associated with various expressions or gestures visible by the camera of the phone, the system software (operating system) of the phone may be patched to allow private rules triggered by the facial recognition system for unlocking the phone to override the normal unlock operation and provide root access to the phone, such that core functions such as access to certain apps, payment systems, email, etc., may be limited by the added security system. The added security system may be integrated with the basic operating system or function as a separate app including one or more patches at the root level or other suitable level of the phone. Thus, the phone may appear to be in an unlocked state with full access to many apps, but in reality the security software app may, in certain security states, merely be feigning full access while hiding the existence of some apps or limiting the use of others, or merely providing feigned apps that do not work but may bring up a screen similar to a functioning app to create the appearance of a fully functional phone. Android phones with patches to the operating system and iPhones with root level changes in the operating system may be considered in these embodiments. The user may also register other users with the security system to provide limited access to certain phone features in response to the facial recognition system recognizing one of these other registered users, but they may be provided with limited functionality. They, in turn, may be allowed to create their own private rules for added security. This may be a useful tool, for example, when making a phone available to a child, friend, or other party who may have a legitimate need for use of the phone, while mitigating risks from abuse, misuse, or theft.

Example 6: Public Enrollment with Personal Rules. In one embodiment, an entity such as a government agency, private company, public company, or NGO seeks to enhance security in a region through the use of facial recognition. Multiple cameras may be installed in public and/or commercial where there may be a security need. While photos may be already be available for much of the population in that region of interest, there is still a need for high-quality documentation of facial features. Higher resolution photos from multiple angle, with multiple expressions, and under multiple lighting conditions could greatly strengthen the value of the facial recognition system by providing a more robust database. To motivate the public or the various people who may be viewed by the facial recognition system to voluntarily submit more detailed facial photographs, an incentive is offered to the body of people in question. The incentive or one of the incentives is the offer of access to a personal rules system that can provide added security for individuals by adding covert cues to fully identify a user without the need for other ID when seeking access to certain service or priority privileges, such as priority access to more desirable seating or services in public transportation or other benefits. Further, with cover rules enabled for signaling duress or other conditions, should a user encounter such a scenario, a particular facial expression or other gesture or combinations thereof may be made in public places to signal to the facial recognition system that there is a need for help. For example, a user facing a kidnap threat may make lick his lips and scratch his left ear upon passing public cameras. The signal may be detected by the public facial recognition system, recognition the application of the predetermined rule for the user. Detection of this cue at more than one location may confirm that it was not a random accident. Security forces may be alerted and a rescue carried out in response to the covert signals made in according with the user's previously established personal rules profile.

### Biometrics and Other Non-Text Channels of Authentication

Biometrics is one form of additional information used in some systems to improve the security in authenticating users. Biometric authentication may requiring hardware and software for scanning and analyzing a unique physiological characteristic such as a fingerprint, handprint, retinal image, and the like. Other biometric approaches for user identification include facial recognition, hand geometry, retinal scan, iris scan, vascular pattern, signature dynamics, and voice dynamics. While biometric authentication is often proposed as a one-part authentication scheme, it can be a hardware-based component of a two-part authentication scheme in combination with a user-supplied password.

Biometrics may be used as one channel in a system with two or more channels of information flow to authenticate user credentials. A non-text-based channels using biometrics or other forms of information exchange may be covert. For example, in gaining access to a secure room, a user may be required to wear a badge with a wireless smart tag for RF scanning to convey encoded information to verify identify, and may be required to also speak a word or phrase to a microphone. The spoken word or phrase may be a unique password that further authenticates the user. Authentication may include not only verification that the correct word or phrase was spoken, but may also include voice recognition to authenticate the user. The entry system may also be provided with means for recognizing covert cues with a plurality of predetermined rules specifying actions responsive to their receipt.

A covert cue may comprise a particular stance of the body or physical action of the user (e.g., left foot forward, majority of the weight on the heel of the right foot, right arm scratching the left should, head tilted to the left, sniffing twice, biting the upper or lower lip, wriggling the nose, closing both eyes for about 0.5 seconds, approaching the portal with a shuffling gate or staggering gate, etc.), or combination of such actions in a particular sequence that can be recognized by sensors, cameras, or other surveillance and monitoring means.

Systems for detecting gestures are discussed by H. Guan et al., “Multi-View Appearance-Based 3D Hand Pose Estimation,” IEEE Workshop on Vision for Human Computer Interaction, New York, N.Y., June 2006, available at http://ilab.cs.ucsb.edu/publications/GuanV4HCI06.pdf, as viewed Jan. 6, 2007; and Y. Zana et al., “Local Approach for Face Verification in Polar Frequency Domain,” Image and Vision Computing, 2006, https://www.academia.edu/2846006/Local_approach_for_face_verification_in_polar_frequency_domain.

### Facial Recognition

In one embodiment, a facial recognition system may comprise software and/or firmware, which may be used to identify nor only a face but also overt cue such as a masked physical action that can convey information according to predetermined Private Rules customized for the system. Object recognition software such as image recognition software may include facial recognition software. The system may also comprise additional sensors to obtain authentication information overtly and/or covertly, such as ultrasonic motion detectors, infrared sensors, load cells, proximity detectors such as those described in U.S. Pat. No. 8,612,856, issued Dec. 17, 2013 to Steve P. Hotelling, and other sensors that may be used to identify an authorized user. In some embodiments, the facial recognition system comprises an eye-tracking system which employs one or more cameras or other sensors to detect the motion of the eyes or the directions the eyes glance toward. Action of the eyes can be a relatively covert physical action that can convey information in addition to the larger-scale recognition of the face. For example, a Private Rules system may be set up to require a specific pattern of eye motion before, during, or after a facial recognition procedure to gain full access. For example, the covert cue may involve an eye motion pattern that first looks below the camera, then above, then to the left and then to the right for about 0.5 seconds for each location, followed by two rapid blinks. In another scenario, the system may require the user, in response to a “look here” message that lights up above a camera, to look diametrically away from the lit up message for at least 1 second followed by a glance above the message. Additional cover cues through voice, other sounds, body motion, hand gestures, facial expressions, etc. can also be coupled with the eye motion.

“Object recognition software,” “facial recognition software,” and “image recognition software” may refer to various embodiments of object recognition software such as those described with respect to various biometric and facial recognition systems herein. Such software may comprise 3D sensor middleware, which may include 3D gesture control and/or object recognition middle ware, such as systems provided by Softkinetic S. A. (Brussels, Belgium), Microsoft Corp. (Redmond, Wash.) and Omek Interactive (Israel).

### Testing, Training and Retuning Modules

The use of Private Rules is enhanced when the user is regularly tested and/or trained on use of the system to ensure that the user can properly take advantage of the system under a wide variety of circumstances, including, for example, emergency situations such as duress or physical threats, and conditions with adverse weather or poor lighting conditions that may require additional means for authentication or conveying signals accurately. In one embodiment, the system comprises a testing module which will periodically challenge a user in a low-risk or private setting with various scenarios to test the user's response. The user may request a test run or a testing opportunity may be prompted by the system. In some embodiments, the user may waive testing at the moment by an overt or covert action such as saying, “postpone.” When the test is accepted, the system may describe a scenario for the user to implement an appropriate Private Rule. A scenario could be described as any of the following, by way of example only:

1. A thief is behind you, forcing you to get into your car with him. Use the facial recognition system for a secret request to carry out the 4 options you have created, namely: A) stop the car from starting, B) run out of gas quickly, C) send an alert to local police and automatically drive to the nearest police car, and D) simulate engine trouble near a safe location within 5 miles. Let's begin with #1 . . . ”

2. There is a blizzard and it is dark. Backup gestures and sounds may be needed to confirm identity since the basic facial recognition system will be impaired. Please provide the backup overt and covert cues for full access.

3. It is a swelteringly hot day and you are dripping with sweat and the sun is shining into the camera, making you backlit. You suspect you are being watched and wish to call for your option of feigned rejection followed by full access 10+ seconds later, giving you time to act frustrated and confuse onlookers with random gestures and voice commands as you turn away, only to have the car instantly open up when you dash back shortly thereafter.

In carrying out testing for any of these scenarios, the system may, at the request of the authorized user, provide hints about the needed signal at any step, or direct the user to review the rules that have already been entered. The system can test the user for recall, speed, and so forth.

The testing module can also evaluate the accuracy of visual recognition with the baseline facial information from initial set up, reflecting possible changes in the user's facial features or facial actions as a result of age, weight gain or loss, tanning, cosmetics use, gender change, injury, surgery, and so forth. For example, out of 100 mathematical features related to the user's face that were all detected and stored during initial setup of a facial recognition system, over time only 90 may still match the database, putting the user in increased danger of denied access if the threshold were, say, 85% matching, especially when evaluated in poor lighting or inclement weather when a camera may be blurred. Thus, the system may request the user to re-establish the facial recognition database that may involve imaging at a specialized facility or taking multiple images at specified angled and lighting conditions. Testing and regular use can then proceed with the refreshed database.

The training module may also keep track of indicators suggesting further testing is needed. These indicator can include the passage of time (e.g., a user-selected condition requiring that every 6 months all actions should have been tested at least once), a measured increase in error rate of the user, or decreased accuracy in the facial recognition results (e.g., the percentage of mathematical measurements matching data in the database for the user).

In training or retuning, the system may identify weaknesses or gaps in the ability of the user to accurately comply with the Private Rule and thus may automatically suggest changes to the rules that better protect the user. Thus, if the user is often failing to provide a machine detectable covert clue masked by a large overt clue, a different clue may be proposed. For facial recognition, a different posture or different facial gesture may be proposed to reduce the risk of error, of being easily detected by onlookers who could imitate the gestures, and so forth.

### Hardware Embodiments

Object recognition systems can comprise hardware adaptations to facilitate the recognition of covert cues, such as providing a first data acquisition device such as a camera, fingerprint reader, iris scanner, retina scanner, microphone for voice recognition, keyboard, PIN pad, card reader, vibration sensor, accelerometer, and the like, or integrated devices comprising multiple sensors such as a fixed monitor installation or a mobile monitor such as a smart phone. The system may further comprise a second data acquisition device or any number of additional data acquisition devices such as any of the aforementioned data acquisition devices, alone or in combination, stationary or mobile, wired or wireless, individually provided or in an integrated unit such as a smart phone or other device with multiple sensors or data input means. In some embodiments, the first data acquisition device is overt and readily recognized by users or observers as a device for data acquisition such as a camera for a facial recognition system, a microphone for possible voice recognition, or card reader, a keyboard for password entry, etc. However, the second device may be, but need not be, covert, meaning that its presence and its purpose may be difficult for untrained users to recognize. The second device may be a hidden camera, for example. In relation to an overt facial recognition system with a system comprising a camera directed toward the face of a user, an overt device such as a hidden camera or inconspicuous, physically remote camera and apparently unrelated object may be directed toward the back of a user, toward the middle of the body to observe hand gestures, for example, or toward the feet to observe the motion or position of the feet. Thus, in one embodiment, an overt facial recognition system is adapted to recognize the face of a user and provide temporary or low-level (limited) or deceptive access to an asset based on successful facial recognition (alone or in combination with other authentication means such as swiping an entry card, entering a password, voice recognition, etc.), while one or more overt data acquisition systems are also obtaining data to determine if conditions of a Private Rules system are being met in order to provide a different level of access or in order to receive other instructions or information based on pre-configured Private Rules.

### Remarks

The order in which steps are executed in any method of the present invention described herein is not essential, unless otherwise indicated. Embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions, and the instructions may be provided or stored on a computer-readable medium, in a carrier wave that can be interpreted and executed by an electronic device, in computer memory, or in other forms of machine executable instructions. The machine-executable instructions may be organized into one or more machine-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When discussing elements or aspects of various embodiments, the articles “a,” “an,” “the,” and “said” indicate that there are one or more elements or aspects. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As changes could be made in the above systems and methods without departing from the embodiments of the invention, it is intended that all matter described above and shown in the accompanying drawings shall be interpreted as illustrative and not in a limiting sense. While the foregoing description makes reference to particular illustrative embodiments, these examples should not be construed as limitations. The inventive system, methods, and devices can be adapted for many other uses not explicitly listed above, and can be modified in numerous ways within the spirit of the present disclosure. Thus, the present invention is not limited to the disclosed embodiments, but is to be accorded the widest scope consistent with the claims below.

We claim:

1. A transportation device equipped with a security system in communication with a facial recognition system and an optional audio input system, the facial recognition system comprising one or more cameras and a memory, the memory comprising:
(a) a database of authorized users associated with facial recognition data,
(b) software for identifying one or more authorized users on the basis of comparing one or more images obtained by the one or more cameras with the facial recognition data in the database, and
(c) personal rules that specify, for one or more of the authorized users, one or more security actions to be taken by the security system in response to a specific action of the one or more of the authorized users, said one or more security actions being selected from limited access, deceptive access, or denied access, and said specific action being selected from a verbal signal received by the optional audio input system if present and an action visible to the one or more cameras, or a combination thereof, said visible action being selected from a gesture, a series of gestures, a facial expression, a series of facial expressions, an action in executing a video CAPTCHA, or any combination thereof; and
(d) a training module adapted to periodically assist the user in practicing use of the personal rules to reduce the risk of failure;
wherein the security system is adapted to prevent at least one of entrance to the transportation device and use of the transportation device in response to a signal received from the security system.

2. The transportation device of claim 1, wherein the action in executing a video CAPTCHA is at least one of a deliberate error and an extraneous action.

3. The transportation device of claim 2, wherein the action in executing a video CAPTCHA is a predetermined deliberate error that is corrected within a specified time period following the deliberate error.

4. The transportation device of claim 1, wherein the transportation device employs a source of stored energy and wherein the security system is configured to simulate at least one of a low stored energy condition and a mechanical or electrical failure to provide limited or deceptive access to the transportation device in response to a specific action according to a setting that can be selected in the personal rules.

5. The transportation device of claim 1, wherein the training device is adapted to evaluate user performance in executing a covert cue required in the personal rules for a certain scenario, and, in response to performance difficulties from the user or covert cue recognition difficulties with the security system, provides guidance to the user recommending a modification of the personal rules for the certain scenario in order to increase the likelihood of successfully executing the covert cue in order to invoke the intended response for the certain scenario.

6. The transportation device of claim 5, wherein the recommended guidance comprises recommending a change in the covert cue associated with the personal rules setting for said certain scenario.

7. The transportation device of claim 1, wherein the one or more cameras include a cell phone camera in communication with the security system via an app, a website, or wireless connection.

8. The transportation device of claim 1, wherein the one or more cameras include a at least one camera mounted on the transportation device, and wherein the personal rules system is adapted for use by a renter to customize security settings for rental use of the transportation device, further comprising a training module to prepare the renter for use of the personal rules prior to accessing the transportation device.

9. The transportation device of claim 1, wherein the specific action is relatively covert.

10. The transportation device of claim 1, wherein the transportation device is adapted for transportation on land, in the air, in or on water, or between floors of a structure.

11. The transportation device of claim 1, further comprising an administrative user interface comprising at least one of a visual display and an audio input/output system, and wherein the wherein the user interface is activated prior to entry of an authorized user into the vehicle, and is adapted to receive visual and verbal signals from the authorized user to select and apply one or more personal rules.

12. The transportation device of claim 11, wherein the personal rules are further adapted to specify an emergency state which, when selected through a visual and/or verbal signal from the authorized user, generates a signal directing the security system to take an emergency response measure to protect the authorized user.

13. The transportation device of claim 12, wherein the transportation device is a vehicle equipped with a plurality of airbags, wherein the personal rules provide for identifying a companion of the authorized user as a security threat, and wherein in such a situation the emergency response is selected from at least one of deploying an airbag in proximity to the companion, automatically bringing the transportation device to an abrupt halt after motion has commenced, wirelessly sending a distress signal to authorities, and autonomously directing the transportation device toward a site proximate to a designated assistance site.

14. A transportation device in operative association with one or more cameras and comprising a non-transitory computer readable media comprising directions for:
a) receiving one or more images from the one or more cameras of a prospective user seeking access to the transportation device;
b) comparing the one or more images to a database of facial recognition data for authorized users of the transportation device to identify the authorization level of the prospective user;
c) in response to authorization level of the prospective user, providing permission to use the transportation device, further determining if the user has specified personal rules in the non-transitory computer-readable media that associate specific covert or relatively covert actions with security-related commands;
d) for a user with specific personal rules, evaluating the one or more images and/or obtaining further images of the user and determining if a specific covert or relatively covert action has been performed to invoke one or more personal rules, and if so, executing the one or more involved personal rules by transmitting a corresponding signal to the transportation device; and
e) for a user with specific personal rules, providing at least one training session to the user to practice making the covert or relatively covert cues cited in the user's personal rules.

15. A security system for protecting a transportation device, comprising one or more cameras for viewing a prospective user of the transportation device, a barrier to access of transportation device, and a non-transitory computer readable medium adapted to communicate with the one or more cameras and the barrier, the non-transitory computer readable medium comprising a facial recognition database, and a personal rules database, and being adapted to:
(a) receive one or more images of a prospective user seeking access to the transportation device;
(b) compare the one or more image of a prospective user to a database of facial recognition data relating to authorized users of the transportation device to identify an authorized user;
(c) determine which personal rules have been established for the identified authorized user,
(d) transmit a signal to regulate the barrier to provide a degree of access to the transportation device according to the personal rules for the authorized user; and
(e) periodically provide one of training or performance evaluation for the use of the personal rules system.

16. The security system of claim 15, wherein the degree of access to the transportation device as defined in at least one personal rule includes providing limited access to the transportation device comprising one of a feigned low fuel or low battery charge condition, a mechanical malfunction, and an electrical malfunction.

17. The security system of claim 15, wherein the degree of access to the transportation device as defined in at least one personal rule includes providing deceptive access to the transportation device.

18. The security system of claim 15, wherein the non-transitory computer readable medium is adapted to provide a graphical user interface to an authorized user providing for selection of personal rules with options displayed for using a facial recognition system to covertly request deceptive access.

19. The security system of claim 15, wherein the non-transitory computer readable medium is adapted to provide a graphical user interface to an authorized user providing for selection of personal rules with options displayed for at least three of:
(1) providing full access to the transportation device, (2) providing deceptive access to the transportation device, (3) providing limited access to the transportation device, (4) taking emergency measures to protect the user from harm or loss, (5) preventing access by an accompanying party or group, (6) providing significant delay to the access, (7) adding additional barriers or burdens to overcome to gain access, and (8) denying access to the transportation device.

20. The security system of claim 21, wherein the non-transitory computer readable medium is adapted to provide a graphical user interface to an authorized user providing for selection of personal rules with options displayed for at least four of: (1) providing full access to the transportation device, (2) providing deceptive access to the transportation device, (3) providing limited access to the transportation device, (4) taking emergency measures to protect the user from harm or loss, (5) preventing access by an accompanying party or group, (6) providing significant delay to the access, (7) adding additional barriers or burdens to overcome to gain access, and (8) denying access to the transportation device.
